(19) United States
(12) Patent Application Publication
(10) Pub. No.: US 2023/0294107 A1
(43) Pub. Date: Sep. 21, 2023

(54) INSPECTION, SORTING, AND PYROLYSIS OF PLASTIC FEEDS

(71) Applicant: Encina Development Group, LLC, The Woodlands, TX (US)

(72) Inventors: Robert REEVES, Denver, CO (US); Carlo BADIOLA, Houston, TX (US)

(73) Assignee: Encina Development Group, LLC, The Woodlands, TX (US)

(21) Appl. No.: 18/122,588

(22) Filed: Mar. 16, 2023

Related U.S. Application Data
(60) Provisional application No. 63/320,737, filed on Mar. 17, 2022.
(60) Provisional application No. 63/320,752, filed on Mar. 17, 2022.

(51) Int. Cl. B03B 9/06; B09B 3/35; B07C 5/36

(52) U.S. Cl. CPC B03B 9/06; B09B 3/35; B07C 5/366; B09B 2101/75

(57) ABSTRACT

The present disclosure relates to apparatus and processes for inspection, sortation, and pysrolysis of waste plastic feeds. In at least one embodiment, a method includes inspecting a waste platic bale, shredding its contents to particles, and sorting those particles based on target identifiers, such as material composition. The sorted material are then pyrolyzed to achaive a desired pyrolysis product.

### CROSS-REFERENCE TO RELATED APPLICATIONS

This application claims benefits of co-pending U.S. Provisional Application No. 63/320,737, filed Mar. 17, 2022 and U.S. Provisional Application No. 63/320,752, filed Mar. 17, 2022.

### FIELD

The present disclosure relates to apparatus and processes for inspection, sortation, and pysrolysis of waste plastic feeds.

### BACKGROUND

Society is becoming increasingly conscious of the vast amounts of plastic materials discarded after a single use. Valuable plastic materials continue to be landfilled despite the numerous technologies proposed to recover plastic from the trash. Many of these technologies are presently inefficient and costly. Thus, investors and communities prefer to continue the lower cost option of discarding the plastic-containing waste in landfills.

Waste plastics are mostly diverted to landfills or are incinerated, with a smaller fraction being diverted to recycling. However, over the years, with increased regulations and levies on landfills, the percentage of the post-consumer waste being recycled or incinerated for energy recovery is gradually increasing.

Attempts have been made to crack the plastic into useful products using conventional cracking apparatus that are used for cracking of petroleum derived feeds such as gas oils. For example, plastic feeds in powder form or pellets have been introduced into fluidized catalytic cracking reactors, which, for plastic feeds, require high temperatures.

In addition, the presence of chlorine in waste plastic (e.g., of polyvinylchloride) promotes corrosion of reactor internals, requiring a separate dechlorination process before the dechlorinated product can be introduced to a reactor and other components of an apparatus. Such additional dechlorination steps (and reactors for dechlorination) reduce throughput and yield of desired cracked products.

Further reducing throughput and yield are spent catalyst (formed in the pyrolysis reactor during pyrolysis). Spent catalyst can be regenerated in a conventional regenerator, but the amount of regeneration is insufficient particularly while using plastic feeds containing chlorine and trace metals.

It would be desirable to the industry to remove such problematic plastics from the feed stream prior to the cracking process. However, such processes of identification and sortation based on chemical compositions can be labour intensive, expensive, and often yield inaccurate results. Additionally, conventional sortation devices have low capacity, require multiple units, and are often inefficient and costly.

There is a need for apparatus and processes providing plastic waste recycling facilities to rapidly screen physical properties and chemical composition of waste plastic upon arrival to recycling facilities. Furthermore, there is a need for apparatus and processes for plastic waste sorting in order to increase throughput and reduce costs associated with plastic cracking processes.

### SUMMARY

In at least one embodiment, a method includes providing a bale comprising plastic to a scale and measuring a mass of the bale using the scale. The method includes rotating or linearly translating the bale to provide access of one or more exterior surfaces of the bale to a plurality of sensors. The method includes detecting a radiation or absence of the radiation of the bale using a radiation sensor of the plurality of sensors to obtain a first data set. The method includes detecting plastic types using a near-infrared spectrum camera of the plurality of sensors to obtain a second data set. The method includes measuring a distance from a fixed reference point during the rotating of the bale using a lidar system of the plurality of sensors to obtain a third data set. The method includes obtaining an exposure of one or more exterior surfaces of the bale using a visible light spectrum camera of the plurality of sensors to obtain a fourth data set. The method includes estimating a mass or a shape of plastic particles of the plastic of the bale using a control system device using the first data set, the second data set, the third data set, the fourth data set, or combination(s) thereof.

In some embodiments, a method, comprising shredding or disaggregating a bale comprising plastic to form a plurality of particles comprising the plastic and introducing the plurality of particles to a first conveyor. The method includes monitoring a first relative abundance of a target material of the plurality of particles using a first sensor device to obtain a first data set, the first relative abundance based on a first property of the target material of the plurality of particles. The method includes providing the first data set from the first sensor device to a second sensor device, transferring the plurality of portions to a second conveyor, and monitoring a second relative abundance of the target material of the plurality of portions using the second sensor device when the plurality of portions is disposed on the second conveyor to obtain a second data set, the second relative abundance based on a second property of the target material of the plurality of portions, wherein the second property is the same as or different than the first property. The method includes transferring one or more portions of the plurality of portions from the second conveyor to a third conveyor or a fourth conveyor depending on the first relative abundance, the second relative abundance, or combination(s) thereof. The method includes transferring one or more portions of the plurality of portions of the third conveyor or the fourth conveyor to a sorting equipment, and sorting the one or more portions of the plurality of portions transferred to the sorting equipment into constituent plastic components. These and other features and attributes of embodiments of the present disclosure and their advantageous applications and/or uses will be apparent from the detailed description which follows.

### BRIEF DESCRIPTION OF THE FIGURES

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally effective aspects.

FIG. 1 is a diagram illustrating a bale inspection system, according to an embodiment.

FIG. 2 is a diagram illustrating a bale sorting system, according to an embodiment.

FIG. 3 is an apparatus and process flow for pyrolysis of plastic feeds, according to an embodiment.

FIG. 4 is a separator, according to an embodiment.

FIG. 5A is a nozzle, according to an embodiment.

FIG. 5B is a nozzle, according to an embodiment.

To facilitate understanding, identical reference numerals have been used, where possible, to designate identical elements that are common to the figures. The figures are not drawn to scale and may be simplified for clarity. It is contemplated that elements and features of one aspect may be beneficially incorporated in other aspects without further recitation.

### DETAILED DESCRIPTION

The present disclosure relates to apparatus and processes for inspection, sortation, and pysrolysis of waste plastic feeds.

In some embodiments, provided is a system and method for intaking and inspecting plastic waste bales to determine the composition and physical characteristics of incoming plastic waste. The data obtained can be used to provide a database of received plastic waste compostion and physical characteristics, tracking and inventory management of such plastic waste, maximize recovery of target plastic waste, and optimize subsequent processing conditions.

In some embodiments, provided is a system and method for sorting and isolating target waste plastic materials for use as a feedstock in subsequent chemical recycling operations.

In some embodiments, provided is a process including introducing a plastic melt, consisting of the isolated target waste plastic, into a reactor via one or more nozzles coupled with the reactor. The process includes introducing a catalyst into the reactor using dilute-phase pneumatic transfer of regenerated catalyst coupled with the reactor via cyclone, standpipe, or vessel-dipleg system. The process includes pyrolyzing the plastic component to form a pyrolysis product. The process includes removing the pyrolysis product from the reactor via a second conduit disposed at a top ½ height of the reactor. The process includes removing the catalyst from the reactor via a third conduit disposed at a bottom ½ height of the reactor, wherein the catalyst removed from the reactor comprises ash. The process includes introducing the catalyst from the third conduit to a separator to form a catalyst-rich phase and an ash-rich phase in the separator.

In some embodiments, provided is an apparatus including one or more nozzles coupled with a reactor. The nozzle includes an inlet disposed substantially perpendicular to a horizontal conduit disposed in the nozzle. The apparatus includes a riser coupled with the reactor. The apparatus includes a first outlet conduit disposed at a top ½ height of the reactor. The first outlet conduit is coupled with a cyclone separator. The apparatus includes a second outlet conduit disposed at a bottom ½ height of the reactor. The second outlet conduit is coupled with a second separator. The apparatus includes a regenerator coupled with the second separator and the riser.

In some embodiments, the bale inspection and sorting process improves cost-effectiveness of the pyrolysis process pertaining to pyrolysis reactor conditions, catalyst composition, catalyst feed input, additive input, and combination(s) thereof. In some embodiments, the bale inspection and sorting process allows for tailorability of pyrolysis process by reducing the energy input required to attain the desired product.

In some embodiments, the bale inspection and sorting process allows for the removal of materials containing problematic heteroatoms prior to pyrolysis. Without being bound by theory, chlorine containing materials can cause corrosion within the pyrolysis reactor resulting in costly repairs and increased downtime. The ability to remove such materials from the plastic waste feedstock prior to pyrolysis mitigate such issues.

### Plastic Waste Sources and Characteristics

Plastic waste can be sourced from one or more operations such as material recovery facilities (MRFs), paper and plastic recyclers, landfills, molding operations, and others that handle scrap plastic materials. Plastic materials can include, but are not limited to, one or more of high density polyethylene (HDPE), low density polyethylene (LDPE), polypropylene (PP), polystyrene (PS), polyethylene terephthalate (PET), polyvinylchloride (PVC), polymethyl acrylate (PMA), polymethyl methacrylate (PMMA), polyvinyl acetate (PVA), acrylonitrile-butadiene-styrene (ABS) plastic, various nylons, various epoxies, various polyurethanes, various polyureas, various polyesters, and other polymers, copolymers, or any combination(s) thereof used in packaging and product manufacture. In some embodiments, the plastic materials are mixed with other non-plastic materials, such as wire, used beverage cans, ferrous metal pieces, wood, paper, and other fiber materials, glass, wood waste, grit, and other inorganic matter. The plastic waste can vary in size and shape to include films, thin sheets, and bulky items. The plastic content can vary widely depending on the source, such as about 10 wt % to about 70 wt %, such as about 25 wt % to about 60 wt %, such as about 35 wt % to about 55 wt %.

The plastic waste materials typically arrive at waste recycling facilities in bales having various shapes, sizes, weights, and compositions. The size and weight can vary according to the source and type of baling device employed to compress and wrap the material. The composition of the bales can vary in physical form and content.

Currently, there is no known method to accurately determine the physical shape and composition of a plastic waste bale prior to and upon arrival at a recycling facility. Knowledge of the plastic waste composition and physical state in a bale is vital to selecting and operating downstream shredding, separation, sorting, washing, and density separation operations—for example, ballistic separators recover film materials from waste. Processes of the present disclosure implement a bale inspection system which can be installed proximate to where the recycling operation receives inbound plastic waste.

The bale inspection system measures the composition and physical characteristics of incoming plastic waste packaged in bales before conveyance to shredding, screening, and sorting operations. In some embodiments, the plastic waste bales have dimensions of height, length, and width.

In some embodiments, one or more sensors measure the size, shape, weight, plastic resin type, and elemental content in the baled material. The data obtained from the one ore more sensors can be recorded, parsed, and evaluated to:
1. Maintain a current database of the composition and characteristics of the incoming baled material.
2. Facilitation of source tracking and inventory management functions.
3. Advance the incoming bale to processes that are appropriate to maximize recovery and purity of the target plastic.
4. Change the setpoints and other control settings of equipment that will process the bale.

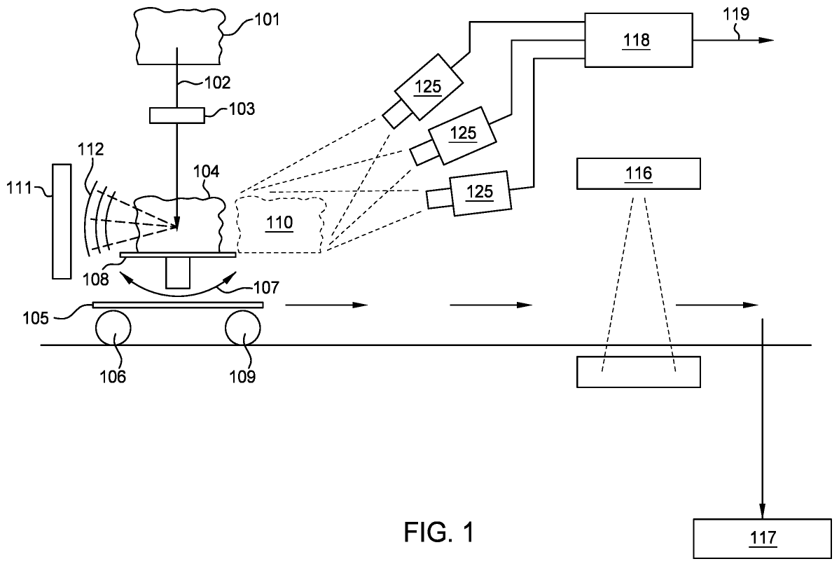

In some embodiments, a bale inspection system includes four sub-modules. The first module comprises mechanical equipment to accept bales from existing material handling equipment proximate to where inbound materials are received from various sources. The mechanical equipment includes components that safely and securely receive and hold a bale in a specified position relative to an array of sensors, as shown in FIG. 1.

Referring to FIG. 1, incoming bales 101 originating from various sources are received by the processing facility and maneuvered by existing material handling systems 102 to an indexer device 103 to sequentially place individual bales 104 on a motorized platter 105. The motorized platter employs a conveyance mechanism 106 rotation system 107 (or linear positioning (not shown)) and electronic scale 108 to measure the mass of the bale. These components allow the bale to be propelled from the indexer along a track 109 to an inspection station 110 wherein the exterior surface (e.g., the entire exterior surface) of the bale is accessible to and analyzed by one or more sensors.

In some embodiments, the one or more sensors are a scale, a near-infrared light reflectance camera (NIR camera), a radiation sensor, a light detection and ranging sensor (LIDAR), a prompt gamma neutron activation analysis (PGNAA) sensor, a visible light camera, and any combination(s) thereof. The sensors provide information pertaining to the physical and compositional aspects of the plastic waste bale. For instance, the scale provides information corresponding to bale mass. The NIR camera takes multiple exposures of the outer surface to ascertain the plastic resin types located proximate to and disposed upon the external surface of the bale. The radiation sensor indicates whether the bale has been contaminated by a radiation source, such as ⁶⁰Co, ¹³⁷Cs ²²³Ra. The LIDAR sensor dynamically measures the distances from a fixed reference point as the bale is rotated or linearly translated on the motorized platter. A plurality of measurements obtained by the LIDAR system is evaluated to obtain a bale's three-dimensional model. The PGNAA sensor provides information regarding the elemental composition of the bale. The visible light camera define the location and texture of particles that are located on the exterior surfaces.

In some embodiments, individual bales 104 are advanced to an inspection station 110 where the one or more sensors have unobstructed access to the individual bale's 104 exposed surface. The an inspection station 110 includes a method of moving and rotating (107 and 108) the individual bale 104 into a position favorable to the one or more sensors. In some embodiments, the individual bale 104 is linearly translated in view of and/or in relation to the one ore more sensors, such that the one or more sensors is able to detect, collect, and convey the desired physical and/or compositional information pertaining to an individual bale 104. In some embodiments, the one or more sensors are rotated around the bale and/or moved linearly along the bale to detect, collect, and convey the desired physical and/or compositional information pertaining to an individual bale 104. The measurement and data collection process is conducted in near real-time to maintain a high level of production. After the measurements are obtained, the individual bale 104 is queued to a temporary inventory location to allow for the measurement evaluation and subsequent dispatch to the appropriate process.

A control system device 118 evaluates all measured data and issues instructions 119 to the facility material handling and process systems. For example, PLC logic can be used where a DCS controller can use prior bale data (bale composition, plastic content in the form of C/H or more detailed offline analysis, or time-logged data from other areas) and correlated back to similar bales compared by source and sensor data.

In some embodiments where the PGNAA sensor is included in the one or more sensors, the individual bale 104 is held in position for a brief period to obtain a measurement of elements, including the significant elements chlorine, sodium, potassium, sulfur, titanium, nickel, copper, aluminum, calcium, iron, silicon, nitrogen, carbon, and others. Information supplied by the PGNAA sensor is integrated with the information provided by the aforementioned sensors to provide knowledge of the proportion and mass of food waste, filler material, tramp metal, and inorganic residues.

Upon completion of the bale inspection process and measurement evaluation, the individual bale 104 is transferred to the processing equipment.

The bale inspection system can receive and integrate the data stream produced by the sensors to estimate one or more of (e.g., each of) the following parameters:
1. Proportion and mass of plastic and residues.
2. Size and shape, and concentration of plastic particles.
3. The concentration of halogens and heteroatoms may be harmful to chemical conversion.
4. The concentration of toxic metals may require treatment before disposal.
5. The concentration of grit and other inorganic residues (metal oxides such as sand) can be landfilled.

The characteristics of numerous bales processed over a specified period may be compared to the weights and purity of products and residues produced over the same period. The comparisons will update the predictive functions of the present systems.

With respect to conventional methods previously established, the bale inspection process and measurements produced is advantageous over the a priori method of processing bales currently practiced by the recycling industry. PLC logic where a DCS controller can use prior bale data (bale composition, plastic content in the form of C/H or more detailed offline analysis, or time-logged data from other areas) and correlated back to similar bales compared by source and sensor data. The net result of dynamically directing the bale to controllable operations provides excellent recovery of high-purity plastic products.

### Bale Sorting Systems:

In some embodiments, bale sorting systems are installed proximate to where the recycling operation receives incoming plastic waste. The bale sorting system provides a process by which the contents that make up the at least one or more individual bales 104 are further sorted prior to pyrolysis, allowing for more efficient determination of processing conditions that will affect the outcome of subsequent pyrolysis and pyrolysis product recovery.

In some embodiments, the contents of the one or more individual bales 104 are subjected to a bulk reduction process prior to sorting the contents of one or more individual bales 104. The bulk reduction process includes any appropriate method of reducing the size of the plastic waste that make up the one or more individual bales 104. In some embodiments, the bulk reduction process includes any one of cutting, grinding, shredding, tearing, perforating, rolling, compressing, mechanically compromising, chemically compromising, electrically compromising, crushing, and any combination(s) thereof. The bulk reduction process increases the detectable surface are of the plastic waste particles 201 which can increase detection accuracy and sortation efficiency.

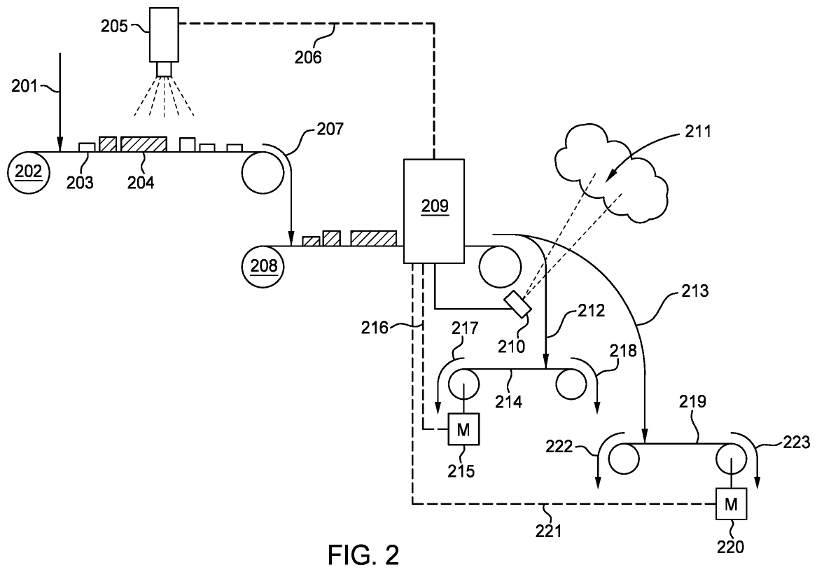

In some embodiments, as illustrated in FIG. 2, a mixture of plastic waste particles 201, that make up the contents of the one or more individual bales 104, are transported by a conveyor 202 past one or more sensors 205 where they are continuously scanned. In some embodiments, the one or more sensors 205 are capable of determining multiple material properties, such as but not limited to, color, reflectance, size, shape, density, weight, opacity to x-rays, and any combination(s) thereof. The relative abundance of plastic waste particles 201 having a select number of distinguishing properties, as determined by the one or more sensors 205, is integrated over a specified period of time and are then sorted by target composition. In some embodiments, the contents of the one or more individual bales 104 are conveyed past the one or more sensors at any suitable throughput rate. In some embodiments, the relative abundance of plastic waste particle measurement has any suitable tolerance.

In some embodiments, the mixture of plastic waste particles 201 are advanced by a high-speed conveyor, such that the plastic waste particles 201 are in view of and detected by the one or more sensors 205. A diverter device, activated when plastic waste particles 201 of a target composition are detected by the one or more sensors 205, modifies the target particles' trajectory as it falls and moves away from the conveyor head pulley. Such a sorting action is referred to as a positive sort command. If the diverter device is programmed not to activate in response to a target particle detection, this is referred to as a negative sort command and such particles are not subject to the diverter device action, thus falling along a natural ballistic trajectory away from the conveyor head pulley. Different material handling systems carry the positively and negatively sorted plastic waste particles 251 to their intended destinations.

In some embodiments, a master sensor device 209 can be implemented to further differentiate and segregate the sorted plastic waste particles 251 having one or more specified target properties. The master sensor device 209 of the present disclosure is in communication with, at least, the one or more sensors 205, a diverter device 210, a negative sort takeaway conveyor 214 and corresponding motor 215, a positive sort takeaway conveyor 219 and corresponding motor 220, and any combination(s) thereof. In some embodiments, when sorted plastic waste particles 251 of one or more specified target properties, as determined by the one or more sensors 205, are in abundance greater than the capacity of the diverter device 210 to reliably move particles to the desired broader trajectory 213, the master sensor device 209 takes no control action. The moving plastic waste particles are discharged to fall in an uninterrupted natural ballistic trajectory 212 onto the negative sort takeaway conveyor 214. This negative sort takeaway conveyor 214 is propelled by a motor 215 whose direction is controlled by the master sensor device 209 via a signal 216 to carry the particles toward the head pulley where they are discharged 217 to receiving equipment or in a reverse direction to toward the tail pulley where they are discharged 218 to different receiving equipment.

In some embodiments, when sorted plastic waste particles 251 having a specified target property, as determined by the one or more sensors 205, are not in abundance greater than a specified value, then the master sensor device 209 activates a diverter device 210 that propels the particles into an alternate broader trajectory 213 using a puff of air 211. The diverted stream of plastic waste particles is moved to the positive sort takeaway conveyor 219 propelled by a motor 220 wherein the direction is controlled by a signal 221 from the master sensor device 209. The signal 221 indicates to the sort takeaway conveyor 219 to carry the particles toward the head pulley where they are discharged 223 to receiving equipment, or in a reverse direction to toward the tail pulley where they are discharged 222 to different receiving equipment.

In some embodiments where a master sensor device 209 is incorporated in a bale sortation system, the sortation is able to effectively sort plastic waste at any suitable rate. In some embodiments where a master sensor device is implemented, the relative abundance of plastic waste particle measurement has any suitable tolerance.

Sorting processes of the present disclosure dynamically modify a target sort command to produce a positive or negative sort action based on the relative abundance of particles possessing one or more target properties (e.g., depending on the chemical content of the polymers). For example, when a mixture of particles contains a low abundance of one or more targets, the particles can be positively sorted without significant recovery loss. As the abundance increases and the capacity of positive sorting are exceeded, the sort command would be given to sort the particles negatively. The negative sorting capacity is naturally much greater than the positive sorting capacity; thus, overall capacity is not reduced. In some embodiments the one or more target properties can include, but are not limited to, particle composition classification (e.g. polyesters, nylons, epoxies, acrylates, etc.), relative elemental abundance (e.g. chlorine content or content of other troublesome elements), particle size, and any combination(s) thereof. In some embodiments wherein relative elemental abundance is a target property, elements of interest can be, but are not limited to, chlorine, sodium, potassium, sulfur, titanium, nickel, copper, aluminum, calcium, iron, silicon, nitrogen, carbon, and any combination(s) thereof.

Two benefits result from dynamically changing the sorting command. First, maximum unit capacity is achieved, and second, the recovery of the target product increases due to less misplaced material.

The present systems and methods achieve dynamic sort commands by pre-inspecting the mixed material stream before it arrives at the sorting device. The relative abundance of one or more target plastic waste particles is measured, and this information is used to compute the optimum sort command, positive or negative. The operation of the material handling equipment downstream of the sorter is adjusted to keep sorted materials flowing to the intended destination. Reversing conveyors are one way to redirect material flow as required by changes in sorting commands.

In some embodiments, plastic particles from either the positive sortation 223 or negative sortation 218 are reintroduced to the bale sorting system, as transported by conveyer 202, to further increase the sortation efficiency and effectiveness of the bale sortation process. The bale sortation process can be reconducted until the positive sortation 223 or negative sortation 218 have the desired composition for pyrolysis.

Existing sorting systems can be upgraded with components of the present disclosure to provide systems with a pre-inspection sensor mounted upstream of the sorter, interface systems, software, and means to control and add to downstream material handling systems.

The bale inspection and sorting process disclosed herein provide improved capacity and recovery of target materials, such as various plastic types for tailored pyrolysis processes. For example, if two plastic materials, one having a high temperature of pyrolysis and one having a low pyrolysis temperature, are pyrolized together in the same reactor, the higher temperature would have to be achieved to have successful pyrolysis. However, if the high temperature pyrolysis material were not present, such an elevated temperature would be unnecessary. Requiring the elevated temperature could be undesirable due to higher energy requirements. The inspection and sorting process disclosed herein allows for the separation of such materials, thereby mitigating the energy input and increasing cost-effectiveness.

Another example of tailorability comes in the form of being able to select the most effective catalyst for the sorted plastic feed that will give the highest yield of the desired product. This will allow the user the ability to make cost-effective decisions regarding catalyst composition, input, and reactor conditions in order to fully optimize the pyrolysis process.

Additionally, the bale inspection and sorting process disclosed herein allow for the removal of materials containing potentially problematic heteroatoms prior to pyrolysis. For example and without being bound by theory, chlorine containing materials (e.g. PVC) can cause corrosion to occur within the pyrolysis reactor which could result in costly repairs and increased downtime. The ability to remove such materials from the plastic waste feedstock prior to pyrolysis can mitigate such issues.

### Reactor Conditions:

Apparatus and processes of the present disclosure provide high throughput of pyrolysis products formed using pyrolysis of plastic waste. Processes can be performed as a single-stage process, providing higher yields than conventional processes for processing waste plastic. Apparatus and processes of the present disclosure provide elutriation of char, char ash, attrited catalyst, and co-injection material such that spent catalyst can be easily regenerated, providing improved throughput of the pyrolysis products in addition to higher purity of recycled catalyst to the reactor. In addition, use of catalyst having a narrow size distribution and larger average diameter than the co-injection material provides elutriation of co-injection material from the catalyst in the reactor. In addition, use of catalyst having a large average diameter, in addition to a reactor configured to provide bubble control, provides reduced plugging and wear of vessel conduits, valves, and other apparatus components, providing maintained integrity and a longer life cycle of apparatus of the present disclosure.

Contents of the positive sortation 223 can include a desired plastic material or composition that is heated to produce a plastic melt to be introduced to a reactor for pyrolysis. In some embodiments, provided is a process including introducing a plastic melt including a plastic component into a reactor via one or more nozzles coupled with the reactor. The process includes introducing a catalyst into the reactor by pneumatic transfer via a first conduit coupling the reactor with a riser. For example, the process may include introducing a catalyst into the reactor using dilute-phase pneumatic transfer of regenerated catalyst coupled with the reactor via cyclone-dipleg system. The process includes pyrolyzing the plastic component to form a pyrolysis product. The process includes removing the pyrolysis product from the reactor via a second conduit disposed at a top ½ height of the reactor and removing the catalyst from the reactor via a third conduit disposed at a bottom ½ height of the reactor.

### Pyrolysis Apparatus and Process Flow:

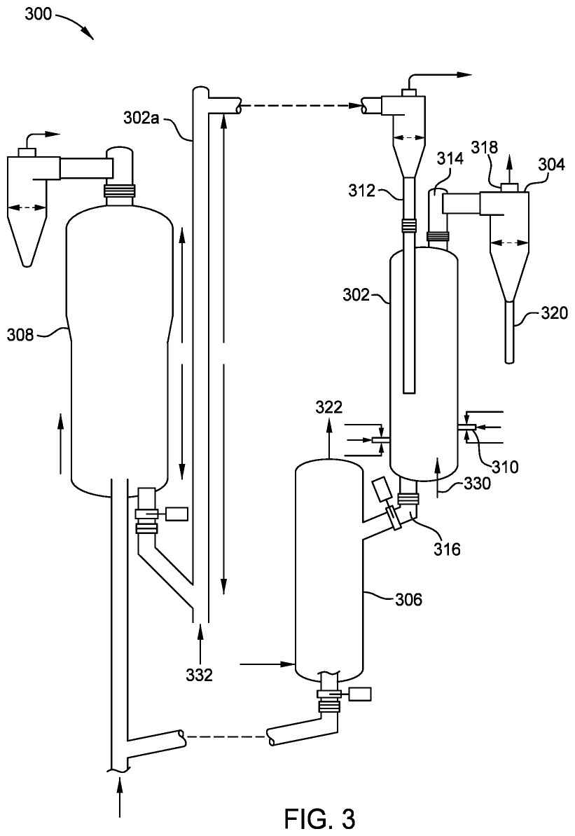

FIG. 3 is an apparatus 300 and process flow for pyrolysis of plastic feeds, according to an embodiment. Apparatus 300 includes a pyrolysis reactor 302, a riser 302a, a first separator 304, a second separator 306, and a regenerator 308.

A plastic melt is introduced into pyrolysis reactor 302 via nozzle 310. The plastic melt can include any suitable plastic material, such as plastic scrap, automotive plastic waste, thermoplastics, thermosets, or combination(s) thereof obtained from a sorting process of the present disclosure. The plastic melt can include one or more plastics such as polyethylene, polypropylene, polystyrene, polyethylene terephthalate, polyvinylchloride, or combination(s) thereof. The plastics can be obtained from recyclable plastics, which can be inspected, reduced into small particles, and sorted based on any one or more appropriate identifying target properties. In some embodiments the one or more target properties can include, but are not limited to, particle composition classification (e.g. polyesters, nylons, epoxies, acrylates, etc.), relative elemental abundance (e.g. chlorine content or content of other troublesome elements), particle size, and any combination(s) thereof. In some embodiments, the plastic melt is introduced into the reactor at a rate of about 60,000 lb/hr to about 100,000 lb/hr, such as about 75,000 lb/hr to about 85,000 lb/hr, alternatively about 30,000 lb/hr to about 50,000 lb/hr. The plastic melt can be provided to the nozzle 310 by a plastic melt source (not shown) that can be configured to provide heat to the plastic to form the plastic melt. In some embodiments, the plastic melt, upon being introduced to the reactor, has a solids (e.g., char) content of about 20 wt % or less upon introduction into reactor 302, such as about 15 wt % or less, such as about 10 wt % or less, such as about 5 wt % or less, such as about 1 wt % or less.

The plastic melt may further include a viscosity reducing agent. For example, a viscosity reducing agent can be a recycled portion of pyrolysis product, such as an organic compound (e.g., aromatic or mono-olefin), such as an ethylene, a propylene, a butene, a benzene, a toluene, a xylene, or combination(s) thereof. The viscosity reducing agent may, additionally or alternatively, include a paraffinic organic compound such as a C₄-C₁₀₀ paraffin, such as a C₆-C₅₀ paraffin, such as a C₁₀-C₃₀ paraffin. The viscosity reducing agent can be introduced to the plastic melt in the plastic melt source (not shown) or nozzle 310. In some embodiments, a weight ratio of plastic to viscosity reducing agent (upon introduction to the reactor) is about 0.5:1 to about 1.5:1, such as about 0.65:1 to about 1.35:1, such as about 0.8:1 to about 1.2:1, such as about 0.95:1 to about 1.05:1, such as about 1:1. In some embodiments where the plastic melt includes a viscosity reducing agent, the plastic melt is introduced into the reactor at a rate of about 60,000 lb/hr to about 200,000 lb/hr, such as about 120,000 lb/hr to about 200,000 lb/hr, such as about 148,000 lb/hr to about 172,000 lb/hr.

A catalyst can be introduced into the pyrolysis reactor 302 via a first conduit 312. Conduit 312 couples reactor 302 to riser 302a. Conduit 112 can be disposed at a top ½ height of the reactor (as shown in FIG. 1) or alternatively can be a dipleg return coupled with riser 302a at a first end and the reactor 302 at a second end such that the second end of the dipleg return (conduit 312) is disposed at the bottom ½ height of the reactor.

The plastic melt and the catalyst in reactor 302 pyrolyze the plastic(s) to form a pyrolysis product. In some embodiments, the catalyst is introduced into reactor 302 via the first conduit 312 at a catalyst flow rate of about 5.5 tons per minute to about 13.8 tons per minute, such as about 7.5 tons per minute to about 12.4 tons per minute, alternatively about 2.5 tons per minute to about 8.8 tons per minute. In some embodiments, the catalyst disposed in the riser 302a has a minimum gas fluidization velocity of about 0.4 ft/sec to about 0.6 ft/sec, such as about 0.45 ft/sec to about 0.55 ft/sec, such as about 0.5 ft/sec to about 0.55 ft/sec. In some embodiments, a weight ratio of catalyst to feed (e.g., plastic melt with or without viscosity reducing agent) in reactor 302 is about 15:1 to about 5:1, such as about 11:1 to about 7:1, such as about 10:1 to about 8:1, such as about 9:1.

The pyrolysis product is removed from reactor 302 via a second conduit 314 disposed at a top ½ height of the reactor. The catalyst is removed from reactor 302 via a third conduit 316 disposed at a bottom ½ height of the reactor. For example, the catalyst can be removed from the reactor via third conduit 316, where third conduit 316 is disposed at a bottom surface of the reactor 302.

In some embodiments, reactor 302 is a bubbling bed reactor. Alternatively, a fluidized bed reactor, slurry reactor, rotating kiln reactor, or packed bed reactor may be used. The plastic melt (e.g., without viscosity reducing agent) can have a temperature of about 900° F. to about 1,100° F., such as about 1,000° F. to about 1,050° F., alternatively about 900° F. to about 1,020° F., during introducing the plastic melt into the reactor. Alternatively, the plastic melt (e.g., with viscosity reducing agent) can have a temperature of about 300° F. to about 700° F., during introducing the plastic melt into the reactor.

In some embodiments, a reactor temperature during pyrolysis of the plastic melt is about 900° F. to about 1,100° F., such as about 1,000° F. to about 1,050° F., alternatively about 900° F. to about 1,020° F. For example, pyrolyzing the plastic may be performed at a reactor temperature of about 900° F. to about 1,100° F., such as about 1,000° F. to about 1,050° F., and/or a reactor pressure of about 20 psig to about 40 psig, such as about 25 psig to about 35 psig, such as about 27 psig to about 33 psig.

Pyrolysis of the present disclosure can provide the pyrolysis product such that the pyrolysis product includes valuable monomers of light gas olefins and aromatics, such as benzene, toluene, xylenes, or combination(s) thereof. The process yields are tunable to the desired yields of olefins and aromatics by using a combination of the catalyst, reactor setup, and process operating conditions. The pyrolysis product can include an organic compound, such as a C₂-C₁₂ hydrocarbon. In some embodiments, the pyrolysis product includes an organic compound selected from the group consisting of ethylene, propylene, and combination(s) thereof. In some embodiments, the pyrolysis product includes an organic compound selected from the group consisting of an ethylene, a propylene, a butene, a benzene, a toluene, a xylene, and combination(s) thereof.

In some embodiments, in addition to the catalyst, a co-injection particle is introduced into reactor 302. For example, a co-injection particle can be introduced into reactor 302 via nozzle 310 at a rate of about 1,000 lb/hr to about 3,000 lb/hr. In some embodiments, a co-injection particle is a particle configured to trap halogens (e.g., fluorine, chlorine, bromine or iodine present in polymers or contaminants of the plastic melt). During the pyrolysis process, such halogens may appear as unwanted contaminants in desired pyrolysis products, or they may be deposited on or react with pyrolysis catalyst components, thereby reducing desirable catalyst properties such as activity and selectivity to desired pyrolysis products. Further, such halogens may be deposited on or react with mechanical components of the pyrolysis system, leading to damage, reduced efficiency or mechanical failure. Further, such halogens may appear as noxious gases or in liquid effluents from outlets of the pyrolysis system. Co-injection particles configured to trap or sequester halogens may include but are not limited to oxides, carbonates, calcium oxide, calcium carbonate, limestone, metal oxides, mixed metal oxides, clays, sands, earths, zeolites, or any other material or combination of materials able to combine with or sequester one or more halogens, in reversible or irreversible manners, thereby reducing or eliminating halogens from desired pyrolysis products, or thereby reducing or eliminating their deleterious deposition on or reaction with pyrolysis catalyst components, or thereby reducing or eliminating their deleterious deposition on or reaction with mechanical components of the pyrolysis system, or thereby reducing or eliminating their appearance as noxious gases or in liquid effluents from outlets of the pyrolysis system. For example, the co-injection particle can be oxides, carbonates, calcium oxide, calcium carbonate, limestone, metal oxides, mixed metal oxides, clays, sands, earths, zeolites, or any other material or combination(s) of materials capable of combining with and sequestering halogens.

In some embodiments, a co-injection particle comprises a material or combination of materials configured to trap or sequester metals and semi-metals that may be present in the plastic melt. A variety of metals and semi-metals may be present in plastic wastes, particularly post-consumer plastic wastes. These metals and semi-metals may include but are not limited to alkali metals, alkaline earth metals, transition metals, rare earths, iron, silver, copper, zinc, gray tin, lead, phosphorus and aluminum, and may be present as free elements or may be present as inorganic or organic or organometallic molecules, compounds, aggregations, mixtures or other combination(s). During the pyrolysis process, such metals and semi-metals may appear as unwanted contaminants in desired pyrolysis products, or they may be deposited on or react with pyrolysis catalyst components, thereby reducing desirable catalyst properties such as activity and selectivity to desired pyrolysis products. Further, such metals and semi-metals may be deposited on or react with mechanical components of the pyrolysis system, leading to damage, reduced efficiency or mechanical failure. Co-injection particles configured to trap or sequester metals and semi-metals may include but are not limited to oxides, carbonates, calcium oxide, calcium carbonate, limestone, metal oxides, mixed metal oxides, clays, sands, earths, zeolites, or any other material or combination of materials able to combine with or sequester one or more metals or semi-metals, in reversible or irreversible manners, thereby reducing or eliminating them from desired pyrolysis products, or thereby reducing or eliminating their deleterious deposition on or reaction with pyrolysis catalyst components, or thereby reducing or eliminating their deleterious deposition on or reaction with mechanical components of the pyrolysis system.

“4A zeolite” (also referred to as LTA zeolite) means a zeolite having pore openings of about 4 angstroms; and the term “5A zeolite” means a zeolite having pore openings of about 5 angstroms.

4A zeolites (Na₂O·Al₂O₃·2SiO₂·9/2H₂O) have a continuous three-dimensional network of channels approximately 4 angstrom in diameter, in addition to larger “cages” approximately 7 Å in diameter. 4A zeolites can have one or more of the following properties: (1) an average particle size of about 3 microns; and/or (2) a silicon:aluminum ratio of about 1.

The pore structure of the 5A zeolites (¾CaO·¼Na₂O·Al₂O₃·2SiO₂·9/2H₂O) is a three-dimensional network of intersecting channels. Entry to the channels is controlled by the eight oxygen atoms from which they are formed (approx. 3-5 Å diameter). Where the channels intersect, larger pores or cages with diameters of 11.4 Å are formed. 5 Å zeolites can have a bulk density of about 0.7 g/cm³ to about 0.75 g/cm³, such as about 0.72 g/cm³.

If calcium oxide is used, the calcium oxide can react with chlorine content of the polymer melt to form calcium chloride and gas product(s) such as carbon dioxide. In some embodiments, a weight ratio of catalyst to co-injection particle in reactor 302 is about 10:1 to about 30:1, such as about 15:1 to about 25:1, such as about 20:1.

The co-injection particle, or product thereof, after sequestration of one or more halogens, or after sequestration of one or more metals or semi-metals, or after sequestration of combinations of one or more halogens, metals or semi-metals, can be removed from the reactor via second conduit 314 and introduced into first separator 304 along with the pyrolysis product.

In some embodiments, the co-injection particle has a smaller average diameter than the average diameter of the pyrolysis catalyst. In such embodiments, in combination with other parameters of the pyrolysis reactor 302, the co-injection particle, or reaction product thereof, (and/or char and attrited catalyst) is able to be removed from reactor 302 to first separator 304 (via a conduit disposed at a top ½ height of the reactor), whereas the larger catalyst particles are removed from reactor 302 via third conduit 316 disposed at a bottom ½ height of the reactor. In some embodiments, a co-injection particle has an average diameter of less than 400 microns, such as less than 200 microns, such as about 50 microns to about 400 microns, such as about 75 microns to about 200 microns, and/or the catalyst has an average diameter of about 500 microns to about 600 microns and/or a narrow particle size distribution.

First separator 304 can be a cyclone separator that is configured to separate the co-injection particle, or product thereof, from the pyrolysis product. The co-injection particle, or product thereof, is removed from first separator 304 via fifth conduit 320 for storage or further processing (e.g., disposal or regeneration). The pyrolysis product is removed from first separator 304 via conduit 318 for storage or further processing (e.g., additional cyclonic separation and/or distillation of products). For example, a second stage of cyclone(s) for secondary removal can be used to increase separation efficiency. Subsequent devices for separation of solids and gases from pyrolysis product can include cyclones, hot gas filters, vortex separators, electrostatic separation, or combination(s) thereof, which can be further added to achieve desired solid removal efficiency.

The catalyst (e.g., spent catalyst) from reactor 302 is introduced into separator 106. In some embodiments, separator 306 is a solid-solid separator. A co-injection particle, or product thereof, from the pyrolysis product can also be removed from separator 306 via sixth conduit 322.

Spent catalyst and ash enter a mid-portion of separator 306. The spent catalyst and ash may further include any residual co-injection particle not separated from the catalyst/ash in the reactor 302. FIG. 3 is a separator 306 of the present disclosure. As shown in FIG. 3, the second end of third conduit 316 is disposed at an angle of about 60° or greater to promote gravimetric flow of the mixture of spent catalyst and ash into separator 306 via third conduit 316. Although the angle shown is about 60°, any suitable angle can be used, such as about 10° to about 90° (vertical inlet), such as about 30° to about 75°, such as about 45° to about 60°. Additionally or alternatively, gas can be introduced into third conduit 316 to promote the flow of the mixture of spent catalyst and ash in third conduit 316 and into separator 306.

In some embodiments, the mixture of spent catalyst and ash entering reactor 306 includes about 90 wt % or greater spent catalyst and about 10 wt % or less ash, such as about 0.5 wt % to about 4 wt % ash and about 96 wt % to about 99.9 wt % spent catalyst. Spent catalyst and ash is introduced into separator 306 at a temperature of about 800° F. to about 1,200° F., such as about 950° F. to about 1,050° F. In some embodiments, spent catalyst and ash are introduced to separator 306 at a rate of about 1 million lbs/hr to about 2 million lbs/hr, such as about 1.3 million lbs/hr to about 1.7 million lbs/hr, such as about 1.4 million lbs/hr to about 1.7 million lbs/hr.

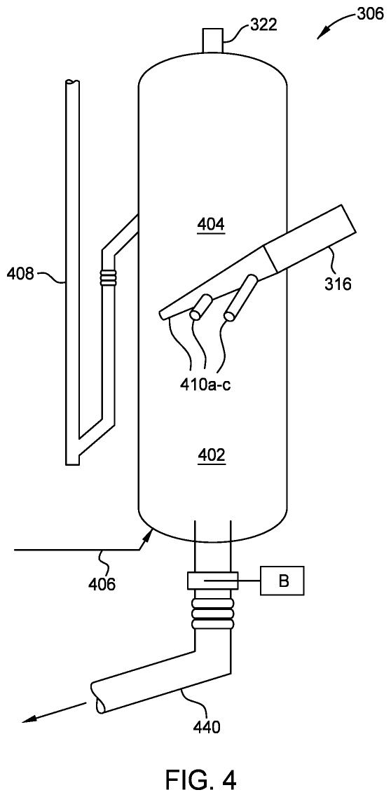

Third conduit 316 has a first end coupled with reactor 302 (of FIG. 3) and a second end coupled with separator 306. As shown in FIG. 4, the second end of third conduit 316 has a plurality of outlets 410a, 410b, and 410c for providing the mixture of spent catalyst and ash into separator 306. Although three outlets 410a-410c are shown in FIG. 4, the second end of third conduit 316 can have any suitable number of outlets, such as a single outlet or about 2 to about 20 outlets, such as about 3 to about 10 outlets, such as about 4 to about 6 outlets. Outlets can be fully or partially open to the separator. A plurality of outlets disposed at the second end of third conduit 316 promotes uniform distribution of the mixture of spent catalyst and ash into separator 306 which, in combination with one or more other features of separator 306, promotes separation of the spent catalyst from the ash. Further, during use, the second end of third conduit 316 is disposed in ash-rich phase 404 (e.g., the second end is disposed at a mid-portion of separator 306 such as disposed at a ¼ to ¾ height of the separator) which promotes separation of spent catalyst from the ash of the mixture being introduced into separator 306 via outlets 410a-c by allowing separation of spent catalyst from the ash followed by settling of the spent catalyst. Once introduced to separator 306, ash separates from the spent catalyst and the ash settles to form the ash-rich phase 404. Likewise, spent catalyst separates from the ash and the spent catalyst settles from the mid-portion of separator 306 toward the bottom portion of separator 306 to form the catalyst-rich phase 402. The “catalyst-rich phase” is rich in spent catalyst and can optionally include an amount of catalyst that is not spent.

Gas is introduced into separator 306 via seventh conduit 406 to fluidize the mixture of spent catalyst and ash. Gas can be provided at a rate of about 0.1 ft/s to about 1.5 ft/s, such as about 0.3 ft/s to about 0.7 ft/s, such as about 0.5 ft/s. The gas can have a temperature of about 150° F. to about 1050° F. The gas can have a lower temperature than the spent catalyst and ash entering separator 306 via third conduit 316 such that the gas can promote cooling of the spent catalyst and ash. In some embodiments, the gas introduced can replace the presence of the trapped reactor gases prior to the introduction into the regenerator combustion system. The rate of gas introduced into separator 306 via seventh conduit 406 can be such that a fine balance is reached between the gas' ability to promote separation of the spent catalyst from the ash and allow the spent catalyst's ability to separate/settle gravimetrically from the ash. Gas in the separator 306 can exit separator 306 via sixth conduit 322 and/or dipleg conduit 408. Ash of ash-rich phase 404 is removed from separator 306 via dipleg outlet 408.

As shown in FIG. 4, the catalyst-rich phase 402 is shown as a bottom phase below the ash-rich phase 404 because, in the embodiments of FIG. 4, the spent catalyst has a higher density and/or a larger particle size than the ash of the ash-rich phase 404. In alternative embodiments, catalyst-rich phase 402 can have a lower density and/or smaller particle size than ash-rich phase 404 and catalyst-rich phase 402 can be above the ash-rich phase 404 in separator 306. In such embodiments, the catalyst-rich phase 402 would be removed from separator 306 via a conduit (not shown) disposed at a mid-portion of separator 306, and the spent catalyst removed by the conduit (not shown) would provide the spent catalyst to the regenerator 308 of FIG. 3. Further in such embodiments, the ash of the ash-rich phase 402 would be disposed toward a bottom portion of separator 106, and the ash would be removed from separator 306 by a conduit (not shown) disposed at a bottom portion of separator 306 for disposal or further processing.

A separation carried out in separator 306 to form the multiple phases can be performed at any suitable pressure and temperature. In some embodiments, a pressure in separator 306 is about 20 psig to about 50 psig, such as about 25 psig to about 40 psig, such as about 30 psig to about 35 psig. In some embodiments, a temperature in separator 306 is about 700° F. to about 1,200° F., such as about 850° F. to about 1,050° F., such as about 950° F. to about 1,000° F.

In some embodiments, the spent catalyst obtained from separator 306 is about 90 wt % or greater, such as about 96 wt % to about 99.9 wt % spent catalyst, relative to the mixture of spent catalyst and ash introduced into separator 306. Likewise, the ash obtained from separator 306 is about 10 wt % or less, such as about 0.5 wt % to about 4 wt % ash, relative to the mixture of spent catalyst and ash introduced into separator 306.

In embodiments where sand is also used in reactor 302 in addition to catalyst, the sand can be separated in separator 306 (e.g., as part of the catalyst-rich phase or as a third phase in addition to the catalyst-rich phase and ash-rich phase). For example, the sand can be disposed in a sand-rich phase that is disposed above or below the catalyst-rich phase 402, and the sand-rich phase can be disposed below the ash-rich phase 404. In such embodiments, the sand-rich phase will be removed from separator 306 via a conduit (not shown) that is disposed below the ash-rich phase 404 and the sand of the sand-rich phase would be removed from separator 306 via the conduit (not shown) that is disposed below the conduit that removed the ash from separator 306.

Additionally or alternatively, in embodiments where trace metals (such as chromium) are separated from the spent catalyst in separator 306. Because trace metals can be denser than a spent catalyst, the trace metals can be separated from spent catalyst and settle as in separator 306 as a metal-rich phase that is disposed below the catalyst-rich phase 402. In such embodiments, the metal-rich phase will be removed from separator 306 via a conduit (not shown) that is disposed below the catalyst-rich phase 402 and the spent-catalyst of the catalyst-rich phase 402 would be removed from separator 306 via a conduit (not shown) that is disposed above the conduit that removed the trace metal from separator 306.

In some embodiments, the conduit used to remove the ash-rich phase from separator can be disposed towards another separator or divided walls acting in series or in stages. Each series or stage geometry can be configured to be separate vessels or discrete chambers integrated into one vessel. Gas can be provided at a rate of about 0.05 ft/s to about 1.5 ft/s, such as about 0.1 ft/s to about 0.3 ft/s, such as about 0.1 ft/s where separation of a third or fourth phase within the ash-rich phase can be achieved to increase separation efficiency from the catalyst-rich phase.

From separator 306, the catalyst (e.g., spent catalyst) is introduced into regenerator 308 via conduit 340 that is configured to form a regenerated catalyst. An oxygen-carrying gas, such as air, may be introduced into the regenerator 308 to regenerate the spent catalyst and combust material (e.g., carbonaceous material disposed on the catalyst such as ash). In some embodiments, air is introduced into the regenerator 308 at a rate of about 107,000 lb/hr to about 165,000 lb/hr, such as about 133,000 lb/hr to about 151,000 lb/hr, such as about 145,000 lb/hr.

The regenerated catalyst formed in regenerator 308 is then introduced into riser 302a.

In some embodiments, the plastic melt is not introduced to the riser 302a. A gas, such as pygas, product gases, reactant gases, recycle gases, or combination(s) thereof, is introduced to the riser 302a via inlet 332. For example, gas is introduced to the riser 302a at a rate of about 18,000 lb/hr to about 23,000 lb/hr, such as about 21,000 lb/hr to about 22,000 lb/hr.

In some embodiments, gas is introduced into reactor 302 via inlet 330. For example, gas can be introduced into reactor 302 via the nozzle at a rate of about 3,000 lb/hr to about 12,000 lb/hr, such as about 7,750 lb/hr to about 10,250 lb/hr. A nozzle can have an outlet having a diameter of about 6 mm to about 20 mm, such as about 13 mm.

The gas introduced to the riser 302a and/or reactor 302 can be refined, product recycled fluid (e.g., gas or liquid). The gas provides a fluidization medium in reactor 302 and also provides improved conversion/yield of reactor feed into pyrolysis product. For example, in embodiments where the gas is a recycled fluid, the recycled fluid can contain olefin material that provides conversion towards a pyrolysis product such as aromatics, increasing target product yield.

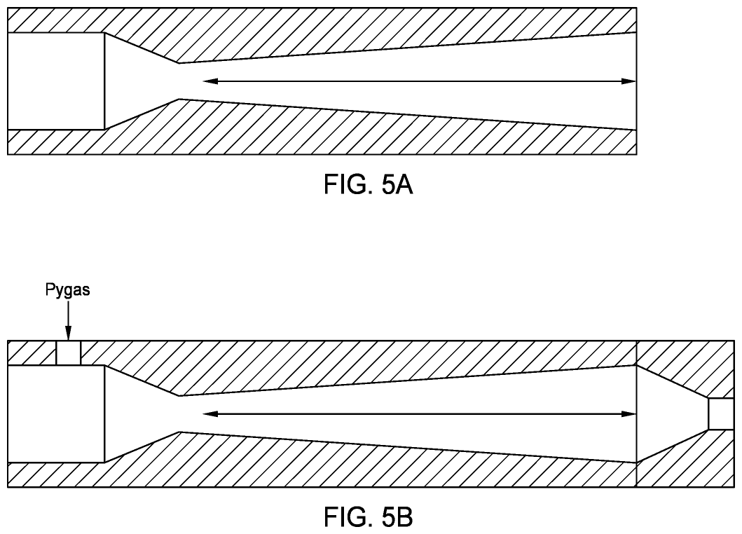

In some embodiments, gas (and/or co-injection material and/or recycle oil) is introduced into the reactor indirectly via an inlet of nozzle 310 and nozzle 310 has an outlet diameter that is smaller than a nozzle interior diameter (as shown in FIG. 5B). For example, a nozzle can have a largest interior diameter of about 10 mm to about 20 mm, such as about 15 mm, and the nozzle can have an outlet having a diameter of about 4 mm to about 12 mm, such as about 8 mm. Gas (in combination with recycle oil) injected into the inlet of the nozzle helps initial shear of the plastic melt into fine droplets. The narrow outlet shears the material again into fine droplets, e.g., 70-80 microns, and disperses the droplets. The fine droplets allow heating of the material quickly for pyrolysis (with less undesired byproduct formation due to reduced residence time needed in the reactor).

During use, catalyst particles in reactor 302 can be in an emulsion phase. Because gas is introduced through riser 302a, into reactor 302, and chemical reaction effluent, bubbles can form within reactor 302. Reactor 302 can be configured to break bubbles that form in the reactor 302. By breaking bubbles in reactor 302, mass transfer of plastic melt to catalyst is promoted. For example, molecules of pyrolyzed plastic getting into pores of catalyst is promoted, which promotes better conversion of plastic to pyrolysis product(s). In addition, formation of large bubbles promotes mechanical vibrations within the reactor, so breaking of the bubbles can reduce or eliminate the occurrence of mechanical vibrations promoted by large bubbles.

In some embodiments, reactor 302 has a plurality of plates, mesh, or structure grid sheds (not shown) disposed within the reactor. For example, the plurality of plates, mesh, or structured grids can have an arrangement in a first row and a second row of plates, mesh, or structured grids, where the first row is horizontally offset from the second row. In some embodiments, one or more of the mesh or grid sheds have an angular apex cover in a vertical direction and have one or more openings along its cover.

### Catalysts:

The catalyst(s) used for pyrolysis of the plastic melt can be any suitable pyrolysis catalyst. In some embodiments, a catalyst is a composite body with multiple components. These components may include one or more materials that are catalytically active in the conversion of plastics in the reactor feed to desired pyrolysis products. These components may, for example, include but are not limited to zeolites, clays, acid impregnated clays, aluminas, silicas, silica-aluminas, spent FCC catalysts, equilibrium FCC catalysts, metal oxides, mixed metal oxides, or combination(s) thereof. The catalyst components may also include one or more materials to bind the catalyst components together to improve their physical strength. Such binder materials may for example include, but are not limited to various aluminas, silicas, magnesias, clays and other earths and minerals. The catalyst components may also include one or more materials to modify other aspects of the composite catalyst bodies, for example density, porosity and pore size distribution. Such modifying materials may include, but are not limited to various aluminum oxides, aluminum hydroxides, aluminum oxyhydroxides, clays, earths, fillers, or combination(s) thereof. Further, such modifying materials may function as hardeners, densifiers, burn out materials to enhance porosity, stabilizers, diluents, activity promoters, activity stabilizers, or combination(s) thereof. Further such modifying materials may include one or more components to sequester feed contaminants such as metals, semi-metals or halogens. Further, such modifying materials may include one or more components to reduce emissions of sulfur oxides, nitrogen oxides, or acid gases from the pyrolysis system. Further, such modifying materials may include one or more components to control and regulate the combustion of carbon and emissions of carbon oxides from the pyrolysis system regenerator. In some embodiments, an additive material is a matrix formed from an active material, such as an active alumina material (amorphous or crystalline), a binder material (such as alumina or silica), an inert filler (such as kaolin), or combination(s) thereof. For example, the catalyst can include a zeolite material disposed in the matrix.

In some embodiments, the various catalyst components are in bodies of one homogeneous composition. In other embodiments, the various components are distributed between two or more bodies that can be physically mixed to achieve the overall desired amounts of the various individual components.

In some embodiments, the catalyst is a Group VIII metal or compound thereof, a Group VIB metal or a metal compound thereof, a Group VIIB metal or a metal compound thereof, or a Group JIB metal or a metal compound thereof, or combination(s) thereof. For example, a Group VIB metal or compound thereof can include molybdenum and/or tungsten. A Group VIII metal or a compound thereof may include nickel and/or cobalt. A Group VIIB metal or a compound thereof may include manganese and/or rhenium. A Group JIB metal or a compound thereof may include zinc and/or cadmium. In some embodiments, a catalyst is a sulfided catalyst. In some embodiments, a catalyst is a cobalt-molybdenum catalyst, a nickel-molybdenum catalyst, a tungsten-molybdenum catalyst, sulfide(s) thereof, or combination(s) thereof. In some embodiments, the catalyst is a platinum-molybdenum catalyst, a tin-platinum catalyst, a platinum gallium catalyst, a platinum-chromium catalyst, a platinum-rhenium, or combination(s) thereof. In some embodiments, a catalyst includes cobalt and molybdenum, nickel and molybdenum, iron and molybdenum, palladium and molybdenum, platinum and molybdenum, or nickel and platinum. A Group IIIB metal or a compound thereof may include lanthanum and/or cerium.

In some embodiments, catalytically active components may include one or more zeolites, which may include but are not limited to X-types, Y-types, mordenites, may be an X-type zeolite, a Y-type zeolite, USY-type zeolite, mordenite, faujasite, nano-crystalline zeolite, an MCM mesoporous material, SBA-15, a silico-alumino phosphate, a gallophosphate, a titanophosphate. In some embodiments, the catalyst may include one or more zeolites (or metal loaded zeolites). In some embodiments, a zeolite is ZSM-5, ZSM-11, aluminosilicate zeolite, ferrierite, heulandite, zeolite A, erionite, chabazite, or combination(s) thereof.

In some embodiments, a catalytically active component is a zeolite, such as a medium-pore zeolite, such as a ZSM-5 zeolite. ZSM-5 zeolite is a molecular sieve that is a porous material having intersecting two-dimensional pore structure with 10-membered oxygen-containing rings. Zeolite materials with such 10-membered oxygen ring pore structure are often classified as medium-pore zeolites. Such medium-pore zeolites typically have pore diameters of 5.0 Angstroms (Å) to 7.0 Å. ZSM-5 zeolite is a medium pore-size zeolite having a pore diameter of about 5.1 Å to about 5.6 Å.

Other properties of ZSM-5 zeolite can include one or more of the following: (1) a SiO₂/Al₂O₃ molar ratio of about 20 to about 600, such as about 30; (2) a Brunauer-Emmett-Teller (BET) surface area (m²/g) of about 320 or greater, such as about 340 or greater, such as about 320 to about 380, such as about 340; and/or (3) in the hydrogen or ammonium ion exchange form.

Catalysts of the present disclosure can have a particle size small enough (1) to allow homogeneous reactor and regenerator fluidization without extreme velocities required, (2) to provide good contacting of catalyst to feed (e.g., plastic melt, recycled pygas, etc.) and reduce/minimize external diffusion barriers, (3) to allow for smooth regeneration without hot spots that might arise if particles are too large, and/or (4) to allow for smooth pneumatic transport without a need for high gas velocities. Catalysts of the present disclosure can have a large enough particle size and density (1) to allow high ratio of catalyst to feed during pyrolysis, (2) to allow higher space velocities (throughput) while minimizing entrainment, (3) to allow for good catalyst separation and discharge from reactor bottom and regenerator bottom, and/or (4) allow efficient separation from lighter, smaller ash or separable phase (non-catalyst solids such as char, co-injected materials) if a separator is used. In some embodiments, the catalyst has an average diameter of about 450 microns to about 650 microns, such as about 500 microns to about 600 microns, such as about 540 microns to about 560 microns.

In some embodiments, the catalyst can have a narrow diameter distribution. For example, the catalyst may have a diameter distribution of about +/−200 microns of the average diameter of the catalyst, such as about +/−150 microns, such as about +/−75 microns. In some embodiments, the catalyst has a D1% value of about 380 microns to about 420 microns, such as about 400 microns. D1% is the diameter of the catalyst such that 99 wt % of the catalyst has a diameter greater than the D1% value. In some embodiments, the catalyst has D99% value of about 680 microns to about 720 microns, such as about 700 microns. D99% is the diameter of the catalyst such that 99 wt % of the catalyst has a diameter less than the D99% value. A narrow size (e.g., diameter) distribution of a catalyst can (1) reduce or minimize dense phase segregation in the reactor and the regenerator, (2) reduce or minimize preferential transport and dilute phase transport at high feed or regenerator air rates, and/or (3) reduce or minimize plugging at vessel discharge ports, slide valves, Y-joints, etc.

In some embodiments, the catalyst has an average particle density of about 300 g/l to about 1,200 g/l, such as about 500 g/l to about 1,000 g/l, such as about 600 g/l to about 800 g/l.

In some embodiments, the catalyst has a sphericity of about 0.9 or greater, such as about 0.95 or greater, such as about 0.99 or greater.

In some embodiments, the catalyst has an active catalyst (e.g., zeolite) loading amount of about 50 wt % or greater, such as about 60 wt % or greater, such as about 75 wt % or greater, such as about 85 wt % or greater, where a remainder balance of the catalyst comprises additive material. For example, additive material can include any suitable binder material.

A catalyst of the present disclosure can have an attrition resistance referred to as an attrition resistance index of less than 10 when measured in a jet cup apparatus at an air jet velocity of 200 ft/sec.

A catalyst of the present disclosure can have a crush strength greater than 1 Newton as measured in a single bead anvil test apparatus, such as greater than 5 Newtons.

In some embodiments, a catalyst is in the form of granules, pellets, extrudates, cut extrudates, ligated extrudates, beads, tablets, spheres, or combination(s) thereof.

Catalysts of the present disclosure may be obtained by any suitable process (such as spray drying) and/or may be obtained from a commercial source. For example, a catalyst can be formed by spray drying, prilling, oil dropping, water dropping, granulating, fluid bed agglomerization, spray coating tableting, extruding, or any combination(s) thereof. Catalysts can be cut, crushed, milled, or screened to provide any suitable size (e.g., diameter) distribution. Catalysts can be further prepared by polishing, densifying, or spheronizing in rotating pans, rotating drums, and the like.

More than one type of catalyst may be introduced to the reactor 302. For example, a first catalyst is introduced to the reactor 302 by a conduit and a second catalyst is introduced to the reactor 302 by a different conduit. The first catalyst and the second catalyst can be introduced into the reactor 302 at the same or different flow rates to control relative amounts of catalyst in reactor 302 at any given time. A remainder balance of the first catalyst and/or the second catalyst can include additive material, such as binder material.

Additionally or alternatively, a first catalyst and a second catalyst are introduced to reactor 302 via a single conduit (as a mixture of catalysts). For example, the mixture of catalysts can be a single-body catalyst including the two catalysts. A remainder balance of the single-body catalyst can include additive material, such as binder material.

In some embodiments, sand of a density of about 1450 g/l to about 1680 g/l can be mixed with a catalyst. Examples of sand include quartz sand, silica sand, sand containing metal or metal oxide, or combination(s) thereof. The use of sand may inhibit fouling of the catalyst by contaminants produced during the pyrolysis. Sand can also provide control of thermal and catalytic activities of pyrolysis occurring in the reactor. Sand may be used at an amount of up to about 99 wt % based on the total amount of sand+catalyst.

### Additional Aspects:

The present disclosure provides, among others, the following aspects, each of which may be considered as optionally including any alternate aspects.
Clause 1. A method, comprising:
   providing a bale comprising plastic to a scale;
   measuring a mass of the bale using the scale;
   rotating or linearly translating the bale to provide access of one or more exterior surfaces of the bale to a plurality of sensors;
   detecting a radiation or absence of the radiation of the bale using a radiation sensor of the plurality of sensors to obtain a first data set;
   detecting plastic types using a near-infrared spectrum camera of the plurality of sensors to obtain a second data set;
   measuring a distance from a fixed reference point during the rotating of the bale using a lidar system of the plurality of sensors to obtain a third data set;
   obtaining an exposure of one or more exterior surfaces of the bale using a visible light spectrum camera of the plurality of sensors to obtain a fourth data set; and
   estimating a mass or a shape of plastic particles of the plastic of the bale using a control system device using the first data set, the second data set, the third data set, the fourth data set, or combination(s) thereof.
Clause 2. The method of Clause 1, wherein the bale has:
   a length of about 0.5 m or greater,
   a width of about 0.5 m or greater, and
   a height of about 0.5 m or greater.
Clause 3. The method of Clauses 1 or 2, wherein the bale has:
   a length of about 0.5 m to about 1 m,
   a width of about 1 m to about 1.5 m, and
   a height of about 1 m to about 2 m.
Clause 4. The method of any of Clauses 1 to 3, wherein the radiation is selected from the group consisting of ⁶⁰Co, ¹³⁷Cs, ²²³Ra, and combination(s) thereof.
Clause 5. The method of any of Clauses 1 to 4, wherein the radiation is detected, and the method further comprises discarding the bale.
Clause 6. The method of any of Clauses 1 to 5, wherein the third data set comprises a plurality of measurements obtained by the lidar system, and the method further comprises constructing a three-dimensional model of the bale using the third data set.
Clause 7. The method of any of Clauses 1 to 6, wherein the plastic of the plastic particles is selected from the group consisting of polyethylene, polypropylene, polystyrene, polyethylene terephthalate, polyvinylchloride, other thermoplastics, non-polyolefin, thermoset plastics, and combination(s) thereof.
Clause 8. The method of any of Clauses 1 to 7, wherein:
   the scale is disposed on a motorized platter, and
   the rotating or the linear translation is performed using the motorized platter.
Clause 9. The method of any of Clauses 1 to 8, further comprising:
   transferring the motorized platter from a first location to a second location; and
   measuring an amount of one or more chemical elements of the bale using a prompt gamma neutron activation analysis (PGNAA) system to obtain a fifth data set.
Clause 10. The method of any of Clauses 1 to 9, wherein the one or more chemical elements are selected from the group consisting of chlorine, sodium, potassium, sulfur, titanium, nickel, copper, aluminum, calcium, iron, silicon, nitrogen, carbon, and combination(s) thereof.
Clause 11. The method of any of Clauses 1 to 10, further comprising estimating a proportion or a mass of food waste, metal (such as aluminum cans, ferrous/non-ferrous materials that are recyclable), or inorganic residue of the bale using the control system device using the first data set, the second data set, the third data set, the fourth data set, the fifth data set, or combination(s) thereof.
Clause 12. The method of any of Clauses 1 to 11, further comprising:
   transferring the bale to equipment configured to sort and/or shred the bale; and
   sorting the bale into constituent plastic components.
Clause 13. The method of any of Clauses 1 to 12, further comprising:
   issuing instruction from the control system device to the equipment; and
   operating the equipment to sort the bale based on the instruction from the control system device to the equipment.
Clause 14. The method of any of Clauses 1 to 13, wherein the instruction is based on the first data set, the second data set, the third data set, the fourth data set, or combination(s) thereof.
Clause 15. The method of any of Clauses 1 to 14, further comprising:
   transferring one or more of the constituent plastic components to a pyrolysis reactor; and
   pyrolyzing the one or more constituent plastic components to form a pyrolysis product.
Clause 16. The method of any of Clauses 1 to 15, wherein the pyrolysis product comprises an organic compound selected from the group consisting of an ethylene, a propylene, a butene, a benzene, a toluene, a xylene, and combination(s) thereof.
Clause 17. The method of any of Clauses 1 to 16, further comprising:
   transferring the bale to equipment configured to sort and/or shred the bale; and
   sorting the bale into constituent plastic components.
Clause 18. The method of any of Clauses 1 to 17, further comprising:
   issuing instruction from the control system device to the equipment; and
   operating the equipment to sort the bale based on the instruction from the control system device to the equipment.
Clause 19. The method of any of Clauses 1 to 18, wherein the instruction is based on the first data set, the second data set, the third data set, the fourth data set, or combination(s) thereof.
Clause 20. The method of any of Clauses 1 to 19, further comprising:
   transferring one or more of the constituent plastic components to a pyrolysis reactor; and
   pyrolyzing the one or more constituent plastic components to form a pyrolysis product.
Clause 21. The method of any of Clauses 1 to 20, wherein the pyrolysis product comprises an organic compound selected from the group consisting of an ethylene, a propylene, a butene, a benzene, a toluene, a xylene, and combination(s) thereof.
Clause 22. An apparatus, comprising:
   a scale sized to dispose thereon a bale comprising plastic;
   a plurality of sensors proximate to the scale, the plurality of sensors comprising:
      a radiation sensor;
      a near-infrared spectrum camera;
      a lidar system; and
      a visible light spectrum camera; and
   a control system device coupled with the radiation sensor, the near-infrared spectrum camera, the lidar system, the visible light spectrum camera, or combination(s) thereof, the control system configured to estimate a mass or a shape of plastic particles of the plastic of the bale using data provided by the radiation sensor, the near-infrared spectrum camera, the lidar system, the visible light spectrum camera, or combination(s) thereof.
Clause 23. The apparatus of Clause 22, further comprising a motorized platter, wherein the scale is disposed on the motorized platter.
Clause 24. The apparatus of Clauses 22 or 23, further comprising a prompt gamma neutron activation analysis (PGNAA) system.
Clause 25. The apparatus of any of Clauses 22 to 24, wherein the control system device is coupled with the radiation sensor, the near-infrared spectrum camera, the lidar system, the visible light spectrum camera, and the PGNAA system.
Clause 26. The apparatus of any of Clauses 22 to 25, wherein the control system device is configured to:
   estimate a mass and a shape of the plastic particles of the plastic of the bale, and
   a proportion and a mass of food waste, metal, and inorganic residue of the bale.
Clause 27. The apparatus of any of Clauses 22 to 26, further comprising:
   an equipment configured to sort and/or shred disposed downstream of the plurality of sensors; and
   a pyrolysis reactor coupled with one or more components of the equipment.
Clause 28. A method, comprising:
   shredding or disaggregating a bale comprising plastic to form a plurality of portions comprising the plastic;
   introducing the plurality of portions to a first conveyor;
   monitoring a first relative abundance of a target material of the plurality of portions using a first sensor device to obtain a first data set, the first relative abundance based on a first property of the target material of the plurality of portions;
   providing the first data set from the first sensor device to a second sensor device;
   transferring the plurality of portions to a second conveyor;
   monitoring a second relative abundance of the target material of the plurality of portions using the second sensor device when the plurality of portions is disposed on the second conveyor to obtain a second data set, the second relative abundance based on a second property of the target material of the plurality of portions, wherein the second property is the same as or different than the first property;
   transferring one or more portions of the plurality of portions from the second conveyor to a third conveyor or a fourth conveyor depending on the first relative abundance, the second relative abundance, or combination(s) thereof;
   transferring one or more portions of the plurality of portions of the third conveyor or the fourth conveyor to a sorting equipment; and
   sorting the one or more portions of the plurality of portions transferred to the sorting equipment into constituent plastic components.
Clause 29. The method of Clause 28, further comprising moving the second conveyor comprising the plurality of portions in a positive or negative direction depending on the first relative abundance of the target material.
Clause 30. The method of Clauses 28 or 29, wherein transferring the one or more portions of the plurality of portions to a third conveyor or a fourth conveyor comprises allowing the one or more portions to fall in a gravity-induced trajectory without supplemental diversion onto the third conveyor.
Clause 31. The method of any of Clauses 28 to 30, further comprising moving the third conveyor comprising the one or more portions of the plurality of portions in a positive or negative direction depending on the first relative abundance of the target material, the second relative abundance of the target material, or combination thereof, wherein moving the third conveyor is performed by a motor coupled with the third conveyor.
Clause 32. The method of any of Clauses 28 to 31, wherein moving the third conveyor comprises providing an instruction from the second sensor device to the motor.
Clause 33. The method of any of Clauses 28 to 32, wherein transferring the one or more portions of the plurality of portions to a third conveyor or a fourth conveyor comprises projecting the one or more portions of the plurality of portions onto the fourth conveyor using a diverter device.
Clause 34. The method of any of Clauses 28 to 33, wherein transferring the one or more portions of the plurality of portions to the fourth conveyor comprises providing an instruction from the second sensor device to the diverter device.
Clause 35. The method of any of Clauses 28 to 34, wherein projecting the one or more portions comprises:
   allowing the one or more portions to fall in a gravity-induced trajectory, and
   providing air flow from the diverter device toward the one or more portions to project the one or more portions of the plurality of portions onto the fourth conveyor.
Clause 36. The method of any of Clauses 28 to 35, wherein allowing the one or more portions to fall in a gravity-induced trajectory comprises allowing the one or more portions to fall in a gravity-induced trajectory toward the third conveyor.
Clause 37. The method of any of Clauses 28 to 36, further comprising moving the fourth conveyor comprising the one or more portions of the plurality of portions in a positive or negative direction depending on the first relative abundance of the target material, the second relative abundance of the target material, or combination thereof, wherein moving the fourth conveyor is performed by a motor coupled with the fourth conveyor.
Clause 38. The method of any of Clauses 28 to 37, wherein moving the fourth conveyor comprises providing an instruction from the second sensor device to the motor.
Clause 39. The method of any of Clauses 28 to 38, wherein the bale has:
   a length of about 0.5 m or greater,
   a width of about 0.5 m or greater, and
   a height of about 0.5 m or greater.
Clause 40. The method of any of Clauses 28 to 39, wherein the bale has:
   a length of about 0.5 m to about 1 m,
   a width of about 1 m to about 1.5 m, and
   a height of about 1 m to about 2 m.
Clause 41. The method of any of Clauses 28 to 40, wherein:
   the plastic comprises polyethylene, polypropylene, polystyrene, polyethylene terephthalate, polyvinylchloride, other thermoplastics, non-polyolefin, thermoset plastics, or combination(s) thereof, and
   the target material is selected from the group consisting of polyethylene, polypropylene, polystyrene, polyethylene terephthalate, polyvinylchloride, and combination(s) thereof.
Clause 42. The method of any of Clauses 28 to 41, wherein the first property is selected from the group consisting of color, reflectance, size, shape, density, weight, opacity to x-rays, and combination(s) thereof.
Clause 43. The method of any of Clauses 28 to 42, wherein the second property is selected from the group consisting of color, reflectance, size, shape, density, weight, opacity to x-rays, and combination(s) thereof.
Clause 44. The method of any of Clauses 28 to 43, wherein the first property is different than the second property.
Clause 45. The method of any of Clauses 28 to 44, further comprising:
   transferring one or more of the constituent plastic components to a pyrolysis reactor; and
   pyrolyzing the one or more constituent plastic components to form a pyrolysis product.
Clause 46. The method of any of Clauses 28 to 45, wherein the pyrolysis product comprises an organic compound selected from the group consisting of an ethylene, a propylene, a butene, a benzene, a toluene, a xylene, and combination(s) thereof.
Clause 47. An apparatus, comprising:
   a shredding equipment or disaggregating equipment configured to shred or disaggregate a bale comprising plastic;
   a first conveyor disposed downstream of the shredding equipment or disaggregating equipment;
   a first sensor device having a first receiver disposed toward the first conveyor;
   a second sensor device electrically coupled with the first sensor device;
   a second conveyor disposed downstream of the first conveyor, wherein the second sensor device has a second receiver disposed toward the second conveyor;
   a third conveyor disposed downstream of the second conveyor;
   a fourth conveyor disposed downstream of the second conveyor; and
   a sorting equipment disposed downstream of the third conveyor or the fourth conveyor.
Clause 48. The apparatus of Clause 47, further comprising a pyrolysis reactor coupled with one or more components of the sorting equipment.
Clause 49. The apparatus of Clauses 47 or 48, further comprising a first motor coupled with the third conveyor, wherein the second sensor device is electrically coupled with the first motor.
Clause 50. The apparatus of any of Clauses 47 to 49, further comprising a second motor coupled with the fourth conveyor, wherein the second sensor device is electrically coupled with the second motor.
Clause 51. The apparatus of any of Clauses 47 to 50, further comprising a diverter device electrically coupled with the second sensor device, wherein the diverter device is configured to project material onto the fourth conveyor.
Clause 52. The apparatus of any of Clauses 47 to 51, wherein:
   the diverter device comprises a gas source, and
   the second sensor device is configured to instruct the diverter device to project the material onto the fourth conveyor via the gas source of the diverter device.
Clause 53. A process, comprising:
   introducing a plastic melt comprising a plastic component into a reactor via a nozzle coupled with the reactor;
   introducing a catalyst into the reactor via a first conduit coupling the reactor with a riser or a regenerator;
   pyrolyzing the plastic component to form a pyrolysis product;
   removing the pyrolysis product from the reactor via a second conduit disposed at a top ½ height of the reactor;
   removing the catalyst from the reactor via a third conduit disposed at a bottom ½ height of the reactor, wherein the catalyst removed from the reactor comprises ash; and
   introducing the catalyst from the third conduit to a separator to form a catalyst-rich phase and an ash-rich phase in the separator.
Clause 54. The process of Clause 53, wherein the third conduit is disposed at an angle of about 30° to about 90° relative to a substantially vertical side of the separator.
Clause 55. The process of Clauses 53 or 54, further comprising introducing a gas to the third conduit.
Clause 56. The process of any of Clauses 53 to 55, wherein the catalyst introduced to the separator has a temperature of about 950° F. to about 1,050° F. when introduced to the separator and is introduced to the separator at a rate of about 1.3 million lbs/hr to about 1.7 million lbs/hr.
Clause 57. The process of any of Clauses 53 to 56, wherein the third conduit has an end disposed within the separator and the end comprises a plurality of outlets.
Clause 58. The process of any of Clauses 53 to 57, wherein the end of the third conduit is disposed at a ¼ to ¾ height of the separator.
Clause 59. The process of any of Clauses 53 to 58, further comprising introducing a gas into the separator via a fourth conduit at a rate of about 0.3 ft/s to about 0.7 ft/s, wherein the gas has a temperature of about 150° F. to about 1050° F.
Clause 60. The process of any of Clauses 53 to 59, wherein forming the catalyst-rich phase and the ash-rich phase in the separator is performed at a pressure of about 25 psig to about 40 psig and a temperature of about 850° F. to about 1,050° F.
Clause 61. The process of any of Clauses 53 to 60, further comprising introducing the catalyst-rich phase to the regenerator.
Clause 62. The process of any of Clauses 53 to 61, wherein the catalyst introduced into the reactor comprises a zeolite and sand and the catalyst introduced from the third conduit to the separator comprises the zeolite, the sand, and the ash.
Clause 63. The process of any of Clauses 53 to 62, wherein introducing the catalyst from the third conduit to the separator further forms a sand-rich phase in the separator, the process further comprising removing the sand-rich phase from the separator via a fourth conduit.
Clause 64. The process of any of Clauses 53 to 63, further comprising sorting a bale comprising the plastic component into a plurality of portions, wherein at least one of the portions comprises the plastic component.
Clause 65. The process of any of Clauses 53 to 64, wherein the reactor is a bubbling bed reactor and the plastic melt has a temperature of about 900° F. to about 1,100° F. during introducing the plastic melt into the reactor.
Clause 66. The process of any of Clauses 53 to 65, wherein the plastic component is selected from the group consisting of polyethylene, polypropylene, polystyrene, polyethylene terephthalate, polyvinylchloride, and combination(s) thereof.
Clause 67. The process of any of Clauses 53 to 66, wherein the pyrolysis product comprises an organic compound selected from the group consisting of an ethylene, a propylene, a butene, a benzene, a toluene, a xylene, and combination(s) thereof.
Clause 68. The process of any of Clauses 53 to 67, further comprising introducing a co-injection particle into the reactor.
Clause 69. The process of any of Clauses 53 to 68, wherein the co-injection particle is introduced into the reactor via the nozzle at a rate of about 1,000 lb/hr to about 3,000 lb/hr.
Clause 70. The process of any of Clauses 53 to 69, further comprising removing the co-injection particle, or product thereof, from the reactor via the second conduit.
Clause 71. The process of any of Clauses 53 to 70, wherein the co-injection particle is calcium oxide and the process includes removing calcium chloride from the reactor via the second conduit.
Clause 72. The process of any of Clauses 53 to 71, wherein the co-injection particle is a zeolite selected from the group consisting of 4A zeolite, 5A zeolite, and combination(s) thereof.
Clause 73. The process of any of Clauses 53 to 72, wherein the co-injection particle has an average diameter of less than 400 microns.
Clause 74. The process of any of Clauses 53 to 73, wherein the co-injection particle has an average diameter of less than 200 microns.
Clause 75. The process of any of Clauses 53 to 74, further comprising:
   introducing the co-injection particle, or product thereof, to a cyclone separator via the second conduit;
   separating the co-injection particle, or product thereof, from the pyrolysis product using the cyclone separator;
   removing the pyrolysis product from the cyclone via a fourth conduit; and
   removing the co-injection particle, or product thereof, from the cyclone via fifth conduit.
Clause 76. The process of any of Clauses 53 to 75, further comprising introducing pygas into the reactor.
Clause 78. The process of any of Clauses 53 to 76, wherein introducing the pygas into the reactor is performed via the nozzle at a rate of about 6,000 lb/hr to about 12,000 lb/hr.
Clause 79. The process of any of Clauses 53 to 77, wherein introducing the plastic melt into the reactor is performed at a rate of about 60,000 lb/hr to about 100,000 lb/hr.
Clause 80. The process of any of Clauses 53 to 79, wherein removing the catalyst from the reactor comprises removing the catalyst from the reactor via the third conduit disposed at a bottom surface of the reactor.
Clause 81. The process of any of Clauses 53 to 80, further comprising introducing the catalyst from the reactor to a separator and a regenerator to form a regenerated catalyst.
Clause 82. The process of any of Clauses 53 to 81, further comprising introducing the regenerated catalyst to the riser or a vessel.
Clause 83. The process of any of Clauses 53 to 82, wherein the plastic melt is not introduced to the riser.
Clause 84. The process of any of Clauses 53 to 83, further comprising introducing gas to the riser.
Clause 85. The process of any of Clauses 53 to 84, wherein pygas is introduced to the riser at a rate of about 9,000 lb/hr to about 11,500 lb/hr.
Clause 86. The process of any of Clauses 53 to 85, wherein the nozzle coupled with the reactor is further coupled with a plastic melt source, wherein the plastic melt source is not the riser.
Clause 87. The process of any of Clauses 53 to 86, wherein the plastic melt further comprises a viscosity reducing agent.
Clause 88. The process of any of Clauses 53 to 87, wherein the viscosity reducing agent comprises an aromatic liquid selected from the group consisting of a benzene, a toluene, a xylene, and combination(s) thereof.
Clause 89. The process of any of Clauses 53 to 88, wherein pyrolyzing the plastic component is performed at a reactor temperature of about 900° F. to about 1,100° F. and a reactor pressure of about 20 psig to about 40 psig.
Clause 90. The process of any of Clauses 53 to 89, wherein pygas is introduced into the reactor via the nozzle and the nozzle has an outlet diameter that is smaller than a nozzle interior diameter.
Clause 91. The process of any of Clauses 53 to 90, wherein introducing the catalyst into the reactor via the first conduit is performed at a catalyst flow rate of about 5.5 tons per minute to about 13.8 tons per minute.
Clause 92. The process of any of Clauses 53 to 91, wherein introducing the catalyst into the reactor via the first conduit is performed at a catalyst flow rate of about 7.5 tons per minute to about 12.4 tons per minute.
Clause 93. The process of any of Clauses 53 to 92, wherein the catalyst is disposed in the riser before being introduced into the reactor and the catalyst has a minimum gas fluidization velocity of about 0.4 ft/sec to about 0.6 ft/sec.
Clause 94. The process of any of Clauses 53 to 93, wherein the catalyst is a zeolite.
Clause 95. The process of any of Clauses 53 to 94, wherein the zeolite is a ZSM-5 zeolite.
Clause 96. The process of any of Clauses 53 to 95, wherein the catalyst has an average diameter of about 500 microns to about 600 microns.
Clause 97. The process of any of Clauses 53 to 96, wherein the catalyst has a D1% value of about 400 microns and a D99% value of about 700 microns.
Clause 98. The process of any of Clauses 53 to 97, wherein the catalyst has a density of about 600 g/l to about 800 g/l.
Clause 99. The process of any of Clauses 53 to 98, wherein the catalyst has a sphericity of about 0.95 or greater.
Clause 100. The process of any of Clauses 53 to 99, wherein the catalyst has a zeolite loading amount of about 50 wt % or greater, wherein a remainder balance of the catalyst comprises additive material.
Clause 101. The process of any of Clauses 53 to 100, wherein the catalyst has a zeolite loading amount of about 75 wt % or greater.
Clause 102. The process of any of Clauses 53 to 101, wherein the additive material comprises a binder material.
Clause 103. The process of any of Clauses 53 to 102, wherein the reactor comprises a plurality of plates, mesh, or square grid comprising a first row of plates, mesh, or square grid and a second row of plates, mesh, or square grid, wherein the first row is horizontally offset from the second row.
Clause 104. The process of any of Clauses 53 to 103, wherein each plate, mesh, or square of the plurality of plates, mesh, or square grid has a tent shape an angular apex cover in a vertical direction and has one or more openings along the cover.
Clause 105. The process of any of Clauses 53 to 104, wherein the plastic melt has a solids content of about 10 wt % or less.
Clause 106. An apparatus, comprising:
   a nozzle coupled with a reactor, the nozzle comprising an inlet disposed substantially perpendicular to a horizontal conduit disposed in the nozzle;
   a riser coupled with the reactor;
   a first outlet conduit disposed at a top ½ height of the reactor, the first outlet conduit coupled with a cyclone separator; and
   a second outlet conduit disposed at a bottom ½ height of the reactor, the second outlet conduit coupled with a second separator;
   a regenerator coupled with the second separator and the riser.
Clause 107. The apparatus of Clause 106, wherein the reactor comprises a plurality of plates, mesh, or square grid comprising a first row and a second row of plates, mesh, or square grid, wherein the first row is horizontally offset from the second row.
Clause 108. The apparatus of Clauses 106 or 107, wherein the second outlet conduit is disposed at a bottom surface of the reactor.
Clause 109. A process, comprising:
   removing a catalyst from a reactor, wherein the catalyst comprises ash;
   introducing the catalyst via a conduit to a separator to form a catalyst-rich phase and an ash-rich phase in the separator; and
   introducing the catalyst-rich phase to a regenerator to form a regenerated catalyst,
   wherein the conduit has an end disposed within the separator at a ¼ to ¾ height of the separator and the end comprises a plurality of outlets.
Clause 110. The process of any of Clauses 53 to 105 or 109, wherein the conduit is disposed at an angle of about 30° to about 90° relative to a substantially vertical side of the separator.
Clause 111. The process of any of Clauses 53 to 105, 109, or 110, further comprising introducing a gas to the conduit.
Clause 112. The process of any of Clauses 53 to 105 or 109 to 111, wherein the catalyst introduced to the separator has a temperature of about 950° F. to about 1,050° F. when introduced to the separator and is introduced to the separator at a rate of about 1.3 million lbs/hr to about 1.7 million lbs/hr.
Clause 113. The process of any of Clauses 53 to 105 or 109 to 112, further comprising introducing a gas into the separator via a second conduit at a rate of about 0.3 ft/s to about 0.7 ft/s, wherein the gas has a temperature of about 150° F. to about 1050° F.
Clause 114. The process of any of Clauses 53 to 105 or 109 to 113, wherein forming the catalyst-rich phase and the ash-rich phase in the separator is performed at a pressure of about 25 psig to about 40 psig and a temperature of about 850° F. to about 1,050° F.
Clause 115. The process of any of Clauses 53 to 105 or 109 to 114, wherein the catalyst introduced into the reactor comprises a zeolite and sand and the catalyst introduced from the conduit to the separator comprises the zeolite, the sand, and the ash.
Clause 116. The process of any of Clauses 1 to 105 or 109 to 115, wherein introducing the catalyst from the conduit to the separator further forms a sand-rich phase in the separator, the process further comprising removing the sand-rich phase from the separator via a second conduit.
Clause 117. The process of any of Clauses 1 to 105 or 109 to 116, further comprising introducing the ash-rich phase to a second separator to form a second catalyst-rich phase and a second ash-rich phase.
Clause 118. The process of Clause 117, wherein the second separator is a stage volume within the first separator.
Clause 119. A process, comprising:
   introducing a plastic melt comprising a plastic component into a reactor via a nozzle coupled with the reactor;
   introducing a catalyst into the reactor via a first conduit coupling the reactor with a riser or regenerator;
   pyrolyzing the plastic component to form a pyrolysis product;
   removing the pyrolysis product from the reactor via a second conduit disposed at a top ½ height of the reactor; and
   removing the catalyst from the reactor via a third conduit disposed at a bottom ½ height of the reactor.
Clause 120. The process of Clause 119, further comprising sorting a bale comprising the plastic component into a plurality of portions, wherein at least one of the portions comprises the plastic component.
Clause 121. The process of Clauses 119 or 120, wherein the reactor is a bubbling bed reactor and the plastic melt has a temperature of about 900° F. to about 1,100° F. during introducing the plastic melt into the reactor.
Clause 122. The process of any of Clauses 119 to 121, wherein the plastic component is selected from the group consisting of polyethylene, polypropylene, polystyrene, polyethylene terephthalate, polyvinylchloride, and combination(s) thereof.
Clause 123. The process of any of Clauses 119 to 122, wherein the pyrolysis product comprises an organic compound selected from the group consisting of an ethylene, a propylene, a butene, a benzene, a toluene, a xylene, and combination(s) thereof.
Clause 124. The process of any of Clauses 119 to 123, further comprising introducing a co-injection particle into the reactor.
Clause 125. The process of any of Clauses 119 to 124, wherein the co-injection particle is introduced into the reactor via the nozzle at a rate of about 1,000 lb/hr to about 3,000 lb/hr.
Clause 126. The process of any of Clauses 119 to 125, further comprising removing the co-injection particle, or product thereof, from the reactor via the second conduit.
Clause 127. The process of any of Clauses 119 to 126, wherein the co-injection particle is calcium oxide and the process includes removing calcium chloride from the reactor via the second conduit.
Clause 128. The process of any of Clauses 119 to 127, wherein the co-injection particle is a zeolite selected from the group consisting of 4A zeolite, 5A zeolite, and combination(s) thereof.
Clause 129. The process of any of Clauses 119 to 128, wherein the co-injection particle has an average diameter of less than 400 microns.
Clause 130. The process of any of Clauses 119 to 129, wherein the co-injection particle has an average diameter of less than 200 microns.
Clause 131. The process of any of Clauses 119 to 130, further comprising:
   introducing the co-injection particle, or product thereof, to a cyclone separator via the second conduit;
   separating the co-injection particle, or product thereof, from the pyrolysis product using the cyclone separator;
   removing the pyrolysis product from the cyclone via a fourth conduit; and
   removing the co-injection particle, or product thereof, from the cyclone via fifth conduit.
Clause 132. The process of any of Clauses 119 to 131, further comprising introducing pygas into the reactor.
Clause 133. The process of any of Clauses 119 to 132, wherein introducing the pygas into the reactor is performed via the nozzle at a rate of about 3,000 lb/hr to about 5,000 lb/hr.
Clause 134. The process of any of Clauses 119 to 133, wherein introducing the plastic melt into the reactor is performed at a rate of about 30,000 lb/hr to about 50,000 lb/hr.
Clause 135. The process of any of Clauses 119 to 134, wherein removing the catalyst from the reactor comprises removing the catalyst from the reactor via the third conduit disposed at a bottom surface of the reactor.
Clause 136. The process of any of Clauses 119 to 135, further comprising introducing the catalyst from the reactor to a separator and a regenerator to form a regenerated catalyst.
Clause 137. The process of any of Clauses 119 to 136, further comprising introducing the regenerated catalyst to the riser or a vessel.
Clause 138. The process of any of Clauses 119 to 137, wherein the plastic melt is not introduced to the riser.
Clause 139. The process of any of Clauses 119 to 138, further comprising introducing gas to the riser.
Clause 140. The process of any of Clauses 119 to 139, wherein pygas is introduced to the riser at a rate of about 9,000 lb/hr to about 11,500 lb/hr.
Clause 141. The process of any of Clauses 119 to 140, wherein the nozzle coupled with the reactor is further coupled with a plastic melt source, wherein the plastic melt source is not the riser.
Clause 142. The process of any of Clauses 119 to 141, wherein the plastic melt further comprises a viscosity reducing agent.
Clause 143. The process of any of Clauses 119 to 142, wherein the viscosity reducing agent comprises an aromatic liquid selected from the group consisting of a benzene, a toluene, a xylene, and combination(s) thereof.
Clause 144. The process of any of Clauses 119 to 143, wherein pyrolyzing the plastic component is performed at a reactor temperature of about 900° F. to about 1,100° F. and a reactor pressure of about 20 psig to about 40 psig.
Clause 145. The process of any of Clauses 119 to 144, wherein pygas is introduced into the reactor via the nozzle and the nozzle has an outlet diameter that is smaller than a nozzle interior diameter.
Clause 146. The process of any of Clauses 119 to 145, wherein introducing the catalyst into the reactor via the first conduit is performed at a catalyst flow rate of about 2.5 tons per minute to about 8.8 tons per minute.
Clause 147. The process of any of Clauses 119 to 146, wherein introducing the catalyst into the reactor via the first conduit is performed at a catalyst flow rate of about 3.5 tons per minute to about 4.4 tons per minute.
Clause 148. The process of any of Clauses 119 to 147, wherein the catalyst disposed in the riser has a minimum gas fluidization velocity of about 0.4 ft/sec to about 0.6 ft/sec.
Clause 149. The process of any of Clauses 119 to 148, wherein the catalyst is a zeolite.
Clause 150. The process of any of Clauses 119 to 149, wherein the zeolite is a ZSM-5 zeolite.
Clause 151. The process of any of Clauses 119 to 150, wherein the catalyst has an average diameter of about 500 microns to about 600 microns.
Clause 152. The process of any of Clauses 119 to 151, wherein the catalyst has a D1% value of about 400 microns and a D99% value of about 700 microns.
Clause 153. The process of any of Clauses 119 to 152, wherein the catalyst has a density of about 600 g/l to about 800 g/l.
Clause 154. The process of any of Clauses 119 to 153, wherein the catalyst has a sphericity of about 0.95 or greater.
Clause 155. The process of any of Clauses 119 to 154, wherein the catalyst has a zeolite loading amount of about 50 wt % or greater, wherein a remainder balance of the catalyst comprises additive material.
Clause 156. The process of any of Clauses 119 to 155, wherein the catalyst has a zeolite loading amount of about 75 wt % or greater.
Clause 157. The process of any of Clauses 119 to 156, wherein the additive material comprises a binder material.
Clause 158. The process of any of Clauses 66 to 157, wherein the reactor comprises a plurality of plates, mesh, or square grid comprising a first row of plates, mesh, or square grid and a second row of plates, mesh, or square grid, wherein the first row is horizontally offset from the second row.
Clause 159. The process of any of Clauses 119 to 158, wherein each plate, mesh, or square of the plurality of plates, mesh, or square grid has a tent shape an angular apex cover in a vertical direction and has one or more openings along the cover.
Clause 160. The process of any of Clauses 119 to 159, wherein the plastic melt has a solids content of about 10 wt % or less.

Overall, systems and methods of the present disclosure provide increased recovery of high-purity plastic materials from bales, reducing or eliminating a need for waste plastic to be discarded at a conventional landfill. Additionally, systems and methods of the present disclosure provide improved capacity and recovery of target materials such as various plastic types for tailored pyrolysis processes. Pyrolysis processes and apparatus of the present disclosure provide high throughput plastic pyrolysis to form pyrolysis products. Processes can be performed as a single-stage process, providing higher yields than conventional processes for processing waste plastic.

The term “pyrolysis” includes an on-average endothermic reaction for converting molecules into (i) atoms and/or (ii) molecules of lesser molecular weight, and/or optionally (iii) molecules of greater molecular weight, e.g., processes for forming C₂-C₁₂ unsaturates such as ethylene, propylene, acetylene, benzene, toluene, xylene, or combination(s) thereof.

The term “catalyst activity” includes the weight of volatile matter converted per catalyst weight over a given amount of time.

The term “spent catalyst” includes any catalyst that has less activity at the same reaction conditions (e.g., temperature, pressure, inlet flows) than the catalyst had when it was originally exposed to the process. This can be due to a number of reasons, several non-limiting examples of causes of catalyst deactivation are coking or char sorption or accumulation, metals sorption or accumulation, attrition, morphological changes including changes in pore sizes, cation or anion substitution, and/or chemical or compositional changes. Spent catalyst can include an amount of catalyst that is not spent (e.g., has not been deactivated) in addition to catalyst that is spent.

The term “regenerated catalyst” includes a catalyst that had become spent, as defined above, and was then subjected to a process that increased its activity, as defined above, to a level greater than it had as a spent catalyst. This may involve, for example, reversing transformations or removing contaminants outlined above as possible causes of reduced activity. The regenerated catalyst may have an activity greater than or equal to the fresh catalyst (typically referred to herein as “catalyst” unless otherwise noted), but typically, regenerated catalyst has an activity that is between the spent and fresh catalyst.

The term “pygas” includes a hydrocarbon fluid (gas or liquid) that is derived from waste plastic material. Pygas can exist as either a raw effluent stream from a reactor or a refined material recycled via a recycle stream for use of fluidization or further conversion in the reactor system.

The term “ash” includes ash that is removed from the reactor and separated from other material. The ash is a solid phase that is considered not part of the size fraction of the catalyst that is circulating through the apparatus. Ash can be attrited catalyst fines, char from plastics, and/or co-injected materials which could be metal-oxides or catalyst by material.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A method, comprising:
providing a bale comprising plastic to a scale;
measuring a mass of the bale using the scale;
rotating or linearly translating the bale to provide access of one or more exterior surfaces of the bale to a plurality of sensors;
detecting a radiation or absence of the radiation of the bale using a radiation sensor of the plurality of sensors to obtain a first data set;
detecting plastic types using a near-infrared spectrum camera of the plurality of sensors to obtain a second data set;
measuring a distance from a fixed reference point during the rotating of the bale using a lidar system of the plurality of sensors to obtain a third data set;
obtaining an exposure of one or more exterior surfaces of the bale using a visible light spectrum camera of the plurality of sensors to obtain a fourth data set; and
estimating a mass or a shape of plastic particles of the plastic of the bale using a control system device using the first data set, the second data set, the third data set, the fourth data set, or combination(s) thereof.

2. The method of claim 1, wherein the bale has:
a length of about 0.5 m or greater,
a width of about 0.5 m or greater, and
a height of about 0.5 m or greater.

3. The method of claim 2, wherein the bale has:
a length of about 0.5 m to about 1 m,
a width of about 1 m to about 1.5 m, and
a height of about 1 m to about 2 m.

4. The method of claim 1, wherein the radiation is selected from the group consisting of ⁶⁰Co, ¹³⁷Cs, ₂₂₃Ra, and combination(s) thereof.

5. The method of claim 1, wherein the radiation is detected, and the method further comprises discarding the bale.

6. The method of claim 1, wherein the third data set comprises a plurality of measurements obtained by the lidar system, and the method further comprises constructing a three-dimensional model of the bale using the third data set.

7. The method of claim 1, wherein the plastic of the plastic particles is selected from the group consisting of polyethylene, polypropylene, polystyrene, polyethylene terephthalate, polyvinylchloride, non-polyolefin, thermoset plastics, and combination(s) thereof.

8. The method of claim 1, wherein:
the scale is disposed on a motorized platter, and
the rotating is performed using the motorized platter.

9. The method of claim 8, further comprising:
transferring the motorized platter from a first location to a second location; and
measuring an amount of one or more chemical elements of the bale using a prompt gamma neutron activation analysis (PGNAA) system to obtain a fifth data set.

10. The method of claim 9, wherein the one or more chemical elements are selected from the group consisting of chlorine, sodium, potassium, sulfur, titanium, nickel, copper, aluminum, calcium, iron, silicon, nitrogen, carbon, and combination(s) thereof.

11. A method, comprising:
shredding or disaggregating a bale comprising plastic to form a plurality of portions comprising the plastic;
introducing the plurality of portions to a first conveyor;
monitoring a first relative abundance of a target material of the plurality of portions using a first sensor device to obtain a first data set, the first relative abundance based on a first property of the target material of the plurality of portions;
providing the first data set from the first sensor device to a second sensor device;
transferring the plurality of portions to a second conveyor;
monitoring a second relative abundance of the target material of the plurality of portions using the second sensor device when the plurality of portions is disposed on the second conveyor to obtain a second data set, the second relative abundance based on a second property of the target material of the plurality of portions, wherein the second property is the same as or different than the first property;
transferring one or more portions of the plurality of portions from the second conveyor to a third conveyor or a fourth conveyor depending on the first relative abundance, the second relative abundance, or combination(s) thereof;
transferring one or more portions of the plurality of portions of the third conveyor or the fourth conveyor to a sorting equipment; and
sorting the one or more portions of the plurality of portions transferred to the sorting equipment into constituent plastic components.

12. The method of claim 11, further comprising moving the second conveyor comprising the plurality of portions in a positive or negative direction depending on the first relative abundance of the target material.

13. The method of claim 11, wherein transferring the one or more portions of the plurality of portions to a third conveyor or a fourth conveyor comprises allowing the one or more portions to fall in a gravity-induced trajectory without supplemental diversion onto the third conveyor.

14. The method of claim 13, further comprising moving the third conveyor comprising the one or more portions of the plurality of portions in a positive or negative direction depending on the first relative abundance of the target material, the second relative abundance of the target material, or combination thereof, wherein moving the third conveyor is performed by a motor coupled with the third conveyor.

15. The method of claim 14, wherein moving the third conveyor comprises providing an instruction from the second sensor device to the motor.

16. The method of claim 11, wherein transferring the one or more portions of the plurality of portions to a third conveyor or a fourth conveyor comprises projecting the one or more portions of the plurality of portions onto the fourth conveyor using a diverter device.

17. The method of claim 16, wherein transferring the one or more portions of the plurality of portions to the fourth conveyor comprises providing an instruction from the second sensor device to the diverter device.

18. The method of claim 17, wherein projecting the one or more portions comprises:
allowing the one or more portions to fall in a gravity-induced trajectory, and
providing air flow from the diverter device toward the one or more portions to project the one or more portions of the plurality of portions onto the fourth conveyor.

19. The method of claim 18, wherein allowing the one or more portions to fall in a gravity-induced trajectory comprises allowing the one or more portions to fall in a gravity-induced trajectory toward the third conveyor.

20. The method of claim 16, further comprising moving the fourth conveyor comprising the one or more portions of the plurality of portions in a positive or negative direction depending on the first relative abundance of the target material, the second relative abundance of the target material, or combination thereof, wherein moving the fourth conveyor is performed by a motor coupled with the fourth conveyor.
